(19) United States
(12) Patent Application Publication
(10) Pub. No.: US 2024/0402891 A1
(43) Pub. Date: Dec. 5, 2024

(54) TECHNIQUES FOR PLACING USER INTERFACE OBJECTS

(71) Applicant: Apple Inc., Cupertino, CA (US)

(72) Inventors: Florentin BEKIER, Boulogne-Billancourt (FR); Raffael HANNEMANN, Paris (FR); Peter L. HAJAS, Lafayette, CO (US); James T. TURNER, San Jose, CA (US)

(21) Appl. No.: 18/618,806

(22) Filed: Mar. 27, 2024

Related U.S. Application Data
(60) Provisional application No. 63/471,252, filed on Jun. 5, 2023.

(51) Int. Cl. G06F 3/04845

(52) U.S. Cl. CPC G06F 3/04845

(57) ABSTRACT

Some techniques are described herein for managing requests for placement of a user interface object within an environment. Some techniques are described herein for requesting placement of a user interface object within an environment.

### CROSS-REFERENCE TO RELATED APPLICATIONS

The present application claims priority to U.S. Provisional Patent Application Ser. No. 63/471,252, entitled “TECHNIQUES FOR PLACING USER INTERFACE OBJECTS” filed Jun. 5, 2023, which is hereby incorporated by reference in its entirety for all purposes.

### BACKGROUND

Electronic devices are becoming increasingly able to support applications with dynamic and/or interactive content. For example, controllers (e.g., user devices and/or computer systems) are often managing displayed content associated with one or more applications. Managing a display environment has become more difficult as the number and complexity of applications executing simultaneously have increased. Accordingly, there is a need to improve techniques for managing displayed content by applications.

### SUMMARY

Current techniques for placing user interface objects are generally ineffective and/or inefficient. For example, some techniques require an application to be limited to displaying content within a defined set of spatial bounds. This disclosure provides more effective and/or efficient techniques for placing user interface objects using an interface between a system process and an application. It should be recognized that other types of electronic devices can be used with techniques described herein. For example, an application can communicate with an application using techniques described herein. In addition, techniques optionally complement or replace other techniques for placing user interface objects.

Some techniques are described herein for managing placement of user interface objects in an environment. Some techniques are described herein for requesting placement of user interface objects in an environment.

In some examples, a method that is performed by a computer system is described. In some examples, the method comprises: receiving, from an application associated with a set of one or more spatial bounds within an environment, a request to place a user interface (UI) object at a location outside of the set of one or more spatial bounds; in response to receiving the request to place the UI object at the location that is outside of the set of one or more spatial bounds and in accordance with a determination that the UI object has a first property and that the location satisfies a set of one or more distance criteria, placing the UI object within the environment and outside of the one or more spatial bounds.

In some examples, a non-transitory computer-readable storage medium storing one or more programs configured to be executed by one or more processors of a computer system is described. In some examples, the one or more programs includes instructions for: receiving, from an application associated with a set of one or more spatial bounds within an environment, a request to place a user interface (UI) object at a location outside of the set of one or more spatial bounds; in response to receiving the request to place the UI object at the location that is outside of the set of one or more spatial bounds and in accordance with a determination that the UI object has a first property and that the location satisfies a set of one or more distance criteria, placing the UI object within the environment and outside of the one or more spatial bounds.

In some examples, a transitory computer-readable storage medium storing one or more programs configured to be executed by one or more processors of a computer system is described. In some examples, the one or more programs includes instructions for: receiving, from an application associated with a set of one or more spatial bounds within an environment, a request to place a user interface (UI) object at a location outside of the set of one or more spatial bounds; in response to receiving the request to place the UI object at the location that is outside of the set of one or more spatial bounds and in accordance with a determination that the UI object has a first property and that the location satisfies a set of one or more distance criteria, placing the UI object within the environment and outside of the one or more spatial bounds.

In some examples, a computer system comprising one or more processors and memory storing one or more programs configured to be executed by the one or more processors is described. In some examples, the one or more programs includes instructions for: receiving, from an application associated with a set of one or more spatial bounds within an environment, a request to place a user interface (UI) object at a location outside of the set of one or more spatial bounds; in response to receiving the request to place the UI object at the location that is outside of the set of one or more spatial bounds and in accordance with a determination that the UI object has a first property and that the location satisfies a set of one or more distance criteria, placing the UI object within the environment and outside of the one or more spatial bounds.

In some examples, a computer system is described. In some examples, the computer system comprises means for performing each of the following steps: receiving, from an application associated with a set of one or more spatial bounds within an environment, a request to place a user interface (UI) object at a location outside of the set of one or more spatial bounds; in response to receiving the request to place the UI object at the location that is outside of the set of one or more spatial bounds and in accordance with a determination that the UI object has a first property and that the location satisfies a set of one or more distance criteria, placing the UI object within the environment and outside of the one or more spatial bounds.

In some examples, a computer program product is described. In some examples, the computer program product comprises one or more programs configured to be executed by one or more processors of a computer system. In some examples, the one or more programs include instructions for: receiving, from an application associated with a set of one or more spatial bounds within an environment, a request to place a user interface (UI) object at a location outside of the set of one or more spatial bounds; in response to receiving the request to place the UI object at the location that is outside of the set of one or more spatial bounds and in accordance with a determination that the UI object has a first property and that the location satisfies a set of one or more distance criteria, placing the UI object within the environment and outside of the one or more spatial bounds.

In some examples, a method that is performed by a computer system is described. In some examples, the method comprises: receiving, from an application associated with a set of one or more spatial bounds within an environment, a request to place a user interface (UI) object within the environment; in response to receiving the request to place the UI object within the environment: in accordance with a determination that the request satisfies a set of one or more criteria, providing, to the application, data representing a location of the UI object within the environment, wherein providing the data representing the location of the UI object within the environment includes providing data representing a location of at least a portion of content corresponding to the application that is outside of the set of one or more spatial bounds in the environment.

In some examples, a non-transitory computer-readable storage medium storing one or more programs configured to be executed by one or more processors of a computer system is described. In some examples, the one or more programs includes instructions for: receiving, from an application associated with a set of one or more spatial bounds within an environment, a request to place a user interface (UI) object within the environment; in response to receiving the request to place the UI object within the environment: in accordance with a determination that the request satisfies a set of one or more criteria, providing, to the application, data representing a location of the UI object within the environment, wherein providing the data representing the location of the UI object within the environment includes providing data representing a location of at least a portion of content corresponding to the application that is outside of the set of one or more spatial bounds in the environment.

In some examples, a transitory computer-readable storage medium storing one or more programs configured to be executed by one or more processors of a computer system is described. In some examples, the one or more programs includes instructions for: receiving, from an application associated with a set of one or more spatial bounds within an environment, a request to place a user interface (UI) object within the environment; in response to receiving the request to place the UI object within the environment: in accordance with a determination that the request satisfies a set of one or more criteria, providing, to the application, data representing a location of the UI object within the environment, wherein providing the data representing the location of the UI object within the environment includes providing data representing a location of at least a portion of content corresponding to the application that is outside of the set of one or more spatial bounds in the environment.

In some examples, a computer system comprising one or more processors and memory storing one or more programs configured to be executed by the one or more processors is described. In some examples, the one or more programs includes instructions for: receiving, from an application associated with a set of one or more spatial bounds within an environment, a request to place a user interface (UI) object within the environment; in response to receiving the request to place the UI object within the environment: in accordance with a determination that the request satisfies a set of one or more criteria, providing, to the application, data representing a location of the UI object within the environment, wherein providing the data representing the location of the UI object within the environment includes providing data representing a location of at least a portion of content corresponding to the application that is outside of the set of one or more spatial bounds in the environment.

In some examples, a computer system is described. In some examples, the computer system comprises means for performing each of the following steps: receiving, from an application associated with a set of one or more spatial bounds within an environment, a request to place a user interface (UI) object within the environment; in response to receiving the request to place the UI object within the environment: in accordance with a determination that the request satisfies a set of one or more criteria, providing, to the application, data representing a location of the UI object within the environment, wherein providing the data representing the location of the UI object within the environment includes providing data representing a location of at least a portion of content corresponding to the application that is outside of the set of one or more spatial bounds in the environment.

In some examples, a computer program product is described. In some examples, the computer program product comprises one or more programs configured to be executed by one or more processors of a computer system. In some examples, the one or more programs include instructions for: receiving, from an application associated with a set of one or more spatial bounds within an environment, a request to place a user interface (UI) object within the environment; in response to receiving the request to place the UI object within the environment: in accordance with a determination that the request satisfies a set of one or more criteria, providing, to the application, data representing a location of the UI object within the environment, wherein providing the data representing the location of the UI object within the environment includes providing data representing a location of at least a portion of content corresponding to the application that is outside of the set of one or more spatial bounds in the environment.

In some examples, a method that is performed by a computer system is described. In some examples, the method comprises: providing, by an application associated with a set of one or more spatial bounds within an environment, to a system process, a request to place a user interface (UI) object at a location outside of the set of one or more spatial bounds; after providing the request to place the UI object at the location that is outside of the set of one or more spatial bounds and in accordance with a determination that the UI object has a first property and that the location satisfies a set of one or more distance criteria, receiving an indication of placement of the UI object within the environment and outside of the one or more spatial bounds.

In some examples, a non-transitory computer-readable storage medium storing one or more programs configured to be executed by one or more processors of a computer system is described. In some examples, the one or more programs includes instructions for: providing, by an application associated with a set of one or more spatial bounds within an environment, to a system process, a request to place a user interface (UI) object at a location outside of the set of one or more spatial bounds; after providing the request to place the UI object at the location that is outside of the set of one or more spatial bounds and in accordance with a determination that the UI object has a first property and that the location satisfies a set of one or more distance criteria, receiving an indication of placement of the UI object within the environment and outside of the one or more spatial bounds.

In some examples, a transitory computer-readable storage medium storing one or more programs configured to be executed by one or more processors of a computer system is described. In some examples, the one or more programs includes instructions for: providing, by an application associated with a set of one or more spatial bounds within an environment, to a system process, a request to place a user interface (UI) object at a location outside of the set of one or more spatial bounds; after providing the request to place the UI object at the location that is outside of the set of one or more spatial bounds and in accordance with a determination that the UI object has a first property and that the location satisfies a set of one or more distance criteria, receiving an indication of placement of the UI object within the environment and outside of the one or more spatial bounds.

In some examples, a computer system comprising one or more processors and memory storing one or more programs configured to be executed by the one or more processors is described. In some examples, the one or more programs includes instructions for: providing, by an application associated with a set of one or more spatial bounds within an environment, to a system process, a request to place a user interface (UI) object at a location outside of the set of one or more spatial bounds; after providing the request to place the UI object at the location that is outside of the set of one or more spatial bounds and in accordance with a determination that the UI object has a first property and that the location satisfies a set of one or more distance criteria, receiving an indication of placement of the UI object within the environment and outside of the one or more spatial bounds.

In some examples, a computer system is described. In some examples, the computer system comprises means for performing each of the following steps: providing, by an application associated with a set of one or more spatial bounds within an environment, to a system process, a request to place a user interface (UI) object at a location outside of the set of one or more spatial bounds; after providing the request to place the UI object at the location that is outside of the set of one or more spatial bounds and in accordance with a determination that the UI object has a first property and that the location satisfies a set of one or more distance criteria, receiving an indication of placement of the UI object within the environment and outside of the one or more spatial bounds.

In some examples, a computer program product is described. In some examples, the computer program product comprises one or more programs configured to be executed by one or more processors of a computer system. In some examples, the one or more programs include instructions for: providing, by an application associated with a set of one or more spatial bounds within an environment, to a system process, a request to place a user interface (UI) object at a location outside of the set of one or more spatial bounds; after providing the request to place the UI object at the location that is outside of the set of one or more spatial bounds and in accordance with a determination that the UI object has a first property and that the location satisfies a set of one or more distance criteria, receiving an indication of placement of the UI object within the environment and outside of the one or more spatial bounds.

In some examples, a method that is performed by a computer system is described. In some examples, the method comprises: providing, by an application associated with a set of one or more spatial bounds within an environment, a request to place a user interface (UI) object within the environment; after providing the request to place the UI object within the environment receiving: data representing a location of the UI object within the environment; and data representing a location of at least a portion of content corresponding to the application that is outside of the set of one or more spatial bounds in the environment.

In some examples, a non-transitory computer-readable storage medium storing one or more programs configured to be executed by one or more processors of a computer system is described. In some examples, the one or more programs includes instructions for: providing, by an application associated with a set of one or more spatial bounds within an environment, a request to place a user interface (UI) object within the environment; after providing the request to place the UI object within the environment receiving: data representing a location of the UI object within the environment; and data representing a location of at least a portion of content corresponding to the application that is outside of the set of one or more spatial bounds in the environment.

In some examples, a transitory computer-readable storage medium storing one or more programs configured to be executed by one or more processors of a computer system is described. In some examples, the one or more programs includes instructions for: providing, by an application associated with a set of one or more spatial bounds within an environment, a request to place a user interface (UI) object within the environment; after providing the request to place the UI object within the environment receiving: data representing a location of the UI object within the environment; and data representing a location of at least a portion of content corresponding to the application that is outside of the set of one or more spatial bounds in the environment.

In some examples, a computer system comprising one or more processors and memory storing one or more programs configured to be executed by the one or more processors is described. In some examples, the one or more programs includes instructions for: providing, by an application associated with a set of one or more spatial bounds within an environment, a request to place a user interface (UI) object within the environment; after providing the request to place the UI object within the environment receiving: data representing a location of the UI object within the environment; and data representing a location of at least a portion of content corresponding to the application that is outside of the set of one or more spatial bounds in the environment.

In some examples, a computer system is described. In some examples, the computer system comprises means for performing each of the following steps: providing, by an application associated with a set of one or more spatial bounds within an environment, a request to place a user interface (UI) object within the environment; after providing the request to place the UI object within the environment receiving: data representing a location of the UI object within the environment; and data representing a location of at least a portion of content corresponding to the application that is outside of the set of one or more spatial bounds in the environment.

In some examples, a computer program product is described. In some examples, the computer program product comprises one or more programs configured to be executed by one or more processors of a computer system. In some examples, the one or more programs include instructions for: providing, by an application associated with a set of one or more spatial bounds within an environment, a request to place a user interface (UI) object within the environment; after providing the request to place the UI object within the environment receiving: data representing a location of the UI object within the environment; and data representing a location of at least a portion of content corresponding to the application that is outside of the set of one or more spatial bounds in the environment.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described examples, reference should be made to the Detailed Description below, in conjunction with the following drawings in which like reference numerals refer to corresponding parts throughout the figures.

FIG. 1 illustrates an example system architecture 100 including various electronic devices that may implement the subject system in accordance with some examples.

FIG. 2 illustrates a block diagram of various components that may be included in an electronic device in accordance with some examples.

FIG. 3 is a block diagram illustrating a computer system in accordance with some examples.

FIG. 4 is a schematic illustrating placement of user interface objects with respect to a spatial bounds of an application.

FIG. 5 is a flow diagram illustrating a method for managing a request to place a user interface object in an environment in accordance with some examples.

FIGS. 6A-6D are schematics illustrating placement of user interface objects with respect to content and spatial bounds of an application.

FIG. 7 is a flow diagram illustrating a method for managing a request to place a user interface object in an environment in accordance with some examples.

FIG. 8 is a flow diagram illustrating a method for requesting placement of a user interface object in an environment in accordance with some examples.

FIG. 9 is a flow diagram illustrating a method for requesting placement of a user interface object in an environment in accordance with some examples.

FIG. 10 illustrates an electronic system with which some examples of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other examples. In some examples, structures and components are shown in block diagram form in order to avoid obscuring the concepts of the subject technology.

Methods and/or processes described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” “third,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described examples. In some examples, the first subsystem and the second subsystem are two separate references to the same subsystem. In some examples, the first subsystem and the second subsystem are both subsystems, but they are not the same subsystem or the same type of subsystem.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some examples, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

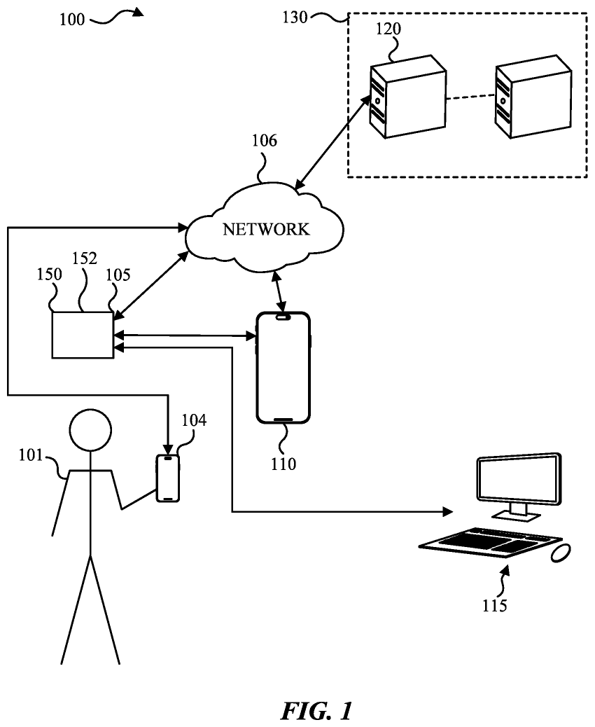

FIG. 1 illustrates an example system architecture 100 including various electronic devices that may implement the subject system in accordance with some examples. Not all of the depicted components may be used in all examples, however, and some examples may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, a handheld electronic device 104, an electronic device 110, an electronic device 115, and a server 120. For explanatory purposes, the system architecture 100 is illustrated in FIG. 1 as including the electronic device 105, the handheld electronic device 104, the electronic device 110, the electronic device 115, and the server 120; however, the system architecture 100 may include any number of electronic devices, and any number of servers or a data center including multiple servers.

The electronic device 105 may be implemented, for example, as a tablet device, a smartphone, or as a head mountable portable system (e.g., worn by a user 101). The electronic device 105 includes a display system capable of presenting a visualization of an extended reality environment to the user. The electronic device 105 may be powered with a battery and/or another power supply. In an example, the display system of the electronic device 105 provides a stereoscopic presentation of the extended reality environment, enabling a three-dimensional visual display of a rendering of a particular scene, to the user. In some examples, instead of, or in addition to, utilizing the electronic device 105 to access an extended reality environment, the user may use a handheld electronic device 104, such as a tablet, watch, mobile device, and the like.

The electronic device 105 may include one or more cameras such as camera(s) 150 (e.g., visible light cameras, infrared cameras, etc.) For example, the electronic device 105 may include multiple cameras 150. For example, the multiple cameras 150 may include a left facing camera, a front facing camera, a right facing camera, a down facing camera, a left-down facing camera, a right-down facing camera, an up facing camera, one or more eye-facing cameras, and/or other cameras. Each of the cameras 150 may include one or more image sensors (e.g., charged coupled device (CCD) image sensors, complementary metal oxide semiconductor (CMOS) image sensors, or the like).

Further, the electronic device 105 may include various sensors 152 including, but not limited to, other cameras, other image sensors, touch sensors, microphones, inertial measurement units (IMU), heart rate sensors, temperature sensors, depth sensors (e.g., Lidar sensors, radar sensors, sonar sensors, time-of-flight sensors, etc.), GPS sensors, Wi-Fi sensors, near-field communications sensors, radio frequency sensors, etc. Moreover, the electronic device 105 may include hardware elements that can receive user input such as hardware buttons or switches. User inputs detected by such cameras, sensors, and/or hardware elements may correspond to, for example, various input modalities. For example, such input modalities may include, but are not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc. In some examples, facial tracking, gaze tracking, hand tracking, gesture tracking, object tracking, and/or physical environment mapping processes (e.g., system processes and/or application processes) may utilize images (e.g., image frames) captured by one or more image sensors of the cameras 150 and/or the sensors 152.

In some examples, the electronic device 105 may be communicatively coupled to a base device such as the electronic device 110 and/or the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power and/or processing limitations of the electronic device 105 such as available battery power of the device. In response to power limitations, the electronic device 105 may deactivate certain sensors within the device itself to preserve battery power and/or to free processing resources.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging the electronic device 105 and/or providing power to the electronic device 105 while physically connected).

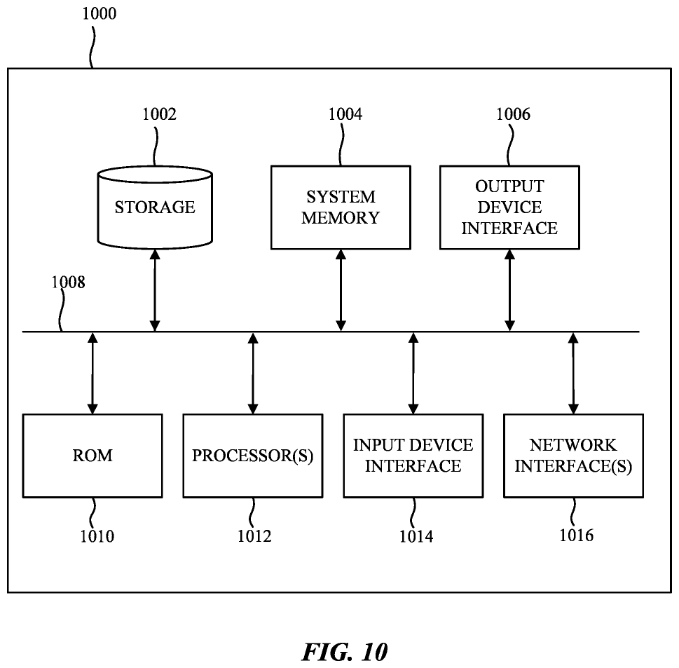

When the electronic device 105 operates in the wireless tethered mode or the connected mode, a least a portion of processing user inputs and/or rendering the extended reality environment may be offloaded to the base device thereby reducing processing burdens on the electronic device 105. For instance, in an example, the electronic device 105 works in conjunction with the electronic device 110 or the electronic device 115 to generate an extended reality environment including physical and/or virtual objects that enables different forms of interaction (e.g., visual, auditory, and/or physical or tactile interaction) between the user and the generated extended reality environment in a real-time manner. In an example, the electronic device 105 provides a rendering of a scene corresponding to the extended reality environment that can be perceived by the user and interacted with in a real-time manner, such as a host environment for a group session with another user. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload. The electronic device 105 may be, and/or may include all or part of, the electronic system discussed below with respect to FIG. 10.

The network 106 may communicatively (directly or indirectly) couple, for example, the electronic device 105, the electronic device 110, and/or the electronic device 115 with each other device and/or the server 120. In some examples, the network 106 may be an interconnected network of devices that may include, or may be communicatively coupled to, the Internet.

The handheld electronic device 104 may be, for example, a smartphone, a portable computing device such as a laptop computer, a companion device (e.g., a digital camera, headphones), a tablet device, a wearable device such as a watch, a band, and the like, or any other appropriate device that includes, for example, one or more speakers, communications circuitry, processing circuitry, memory, a touchscreen, and/or a touchpad. In some examples, the handheld electronic device 104 may not include a touchscreen but may support touchscreen-like gestures, such as in an extended reality environment. In some examples, the handheld electronic device 104 may include a touchpad. In FIG. 1, by way of example, the handheld electronic device 104 is depicted as a tablet device.

The electronic device 110 may be, for example, a smartphone, a portable computing device such as a laptop computer, a companion device (e.g., a digital camera, headphones), a tablet device, a wearable device such as a watch, a band, and the like, or any other appropriate device that includes, for example, one or more speakers, communications circuitry, processing circuitry, memory, a touchscreen, and/or a touchpad. In some examples, the electronic device 110 may not include a touchscreen but may support touchscreen-like gestures, such as in an extended reality environment. In some examples, the electronic device 110 may include a touchpad. In FIG. 1, by way of example, the electronic device 110 is depicted as a tablet device. In some examples, the electronic device 110, the handheld electronic device 104, and/or the electronic device 105 may be, and/or may include all or part of, the electronic system discussed below with respect to FIG. 10. In some examples, the electronic device 110 may be another device such as an Internet Protocol (IP) camera, a tablet, or a companion device such as an electronic stylus, etc.

The electronic device 115 may be, for example, desktop computer, a portable computing device such as a laptop computer, a smartphone, a companion device (e.g., a digital camera, headphones), a tablet device, a wearable device such as a watch, a band, and the like. In FIG. 1, by way of example, the electronic device 115 is depicted as a desktop computer having one or more cameras 150 (e.g., multiple cameras 150). The electronic device 115 may be, and/or may include all or part of, the electronic system discussed below with respect to FIG. 10.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for extended reality environments. In an example, the server 120 may function as a cloud storage server that stores any of the aforementioned extended reality content generated by the above-discussed devices and/or the server 120.

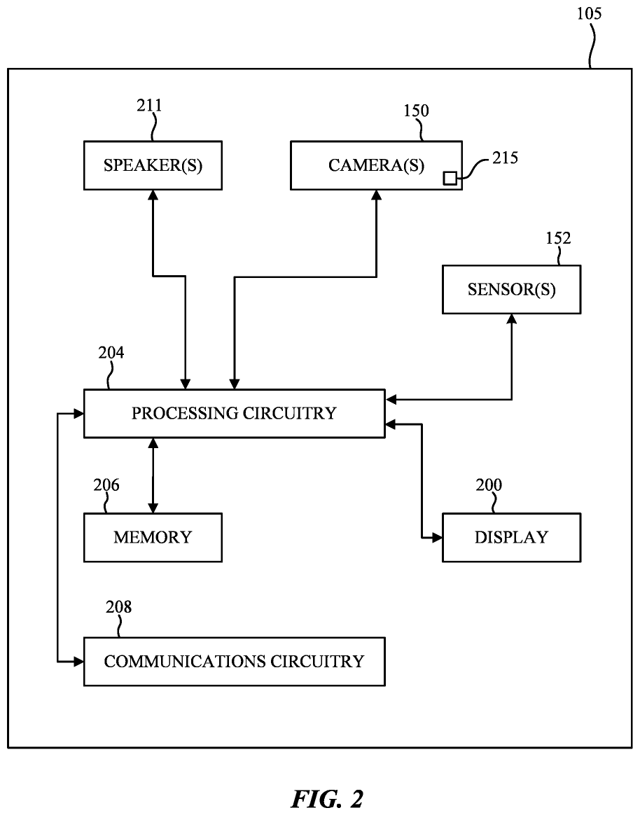

FIG. 2 illustrates a block diagram of various components that may be included in electronic device 105, in accordance with some examples. As shown in FIG. 2, electronic device 105 may include one or more cameras such as camera(s) 150 (e.g., multiple cameras 150, each including one or more image sensors 215) that capture images and/or video of the physical environment around the electronic device, one or more sensors 152 that obtain environment information (e.g., depth information) associated with the physical environment around the electronic device 105. Sensors 152 may include depth sensors (e.g., time-of-flight sensors, infrared sensors, radar, sonar, lidar, etc.), one or more microphones, and/or other types of sensors for sensing the physical environment. For example, one or more microphones included in the sensor(s) 152 may be operable to capture audio input from a user of the electronic device 105, such as a voice input corresponding to the user speaking into the microphones. In the example of FIG. 2, electronic device 105 also includes communications circuitry 208 for communication with electronic device 110, electronic device 115, servers 120, and/or other devices and/or systems in some examples. Communications circuitry 208 may include radio frequency (RF) communications circuitry for detecting radio frequency identification (RFID) tags, Bluetooth Low Energy (BLE) communications circuitry, other near-field communications (NFC) circuitry, Wi-Fi communications circuitry, cellular communications circuitry, and/or other wired and/or wireless communications circuitry.

As shown, electronic device 105 includes processing circuitry 204 (e.g., one or more processors and/or integrated circuits) and memory 206. Memory 206 may store (e.g., temporarily or permanently) content generated by and/or otherwise obtained by electronic device 105. In some operational scenarios, memory 206 may temporarily store images of a physical environment captured by camera(s) 150, depth information corresponding to the images generated, for example, using a depth sensor of sensors 152, meshes and/or textures corresponding to the physical environment, virtual objects such as virtual objects generated by processing circuitry 204 to include virtual content, and/or virtual depth information for the virtual objects. Memory 206 may store (e.g., temporarily or permanently) intermediate images and/or information generated by processing circuitry 204 for combining the image(s) of the physical environment and the virtual objects and/or virtual image(s) to form, e.g., composite images for display by display 200, such as by compositing one or more virtual objects onto a pass-through video stream obtained from one or more of the cameras 150.

As shown, the electronic device 105 may include one or more speakers 211. The speakers may be operable to output audio content, including audio content stored and/or generated at the electronic device 105, and/or audio content received from a remote device or server via the communications circuitry 208.

Memory 206 may store instructions or code for execution by processing circuitry 204, such as, for example operating system code corresponding to an operating system installed on the electronic device 105, and application code corresponding to one or more applications installed on the electronic device 105. The operating system code and/or the application code, when executed, may correspond to one or more operating system level processes and/or application level processes, such as processes that support capture of images, obtaining and/or processing environmental condition information, and/or determination of inputs to the electronic device 105 and/or outputs (e.g., display content on display 200) from the electronic device 105.

In some examples, one or more input devices include one or more camera sensors (e.g., one or more optical sensors and/or one or more depth camera sensors such as for tracking a user's gestures (e.g., hand gestures and/or air gestures) as input. In some examples, the one or more input devices are integrated with the computer system. In some examples, the one or more input devices are separate from the computer system. In some examples, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

Attention is now directed towards techniques for placing user interface objects. Such techniques are described in the context of a system process of a computer communicating with a user application. It should be recognized that software architectures can be used with techniques described herein. For example, a user application of a computer can communicate with another user application using techniques described herein. In addition, techniques optionally complement or replace other techniques for placing user interface objects.

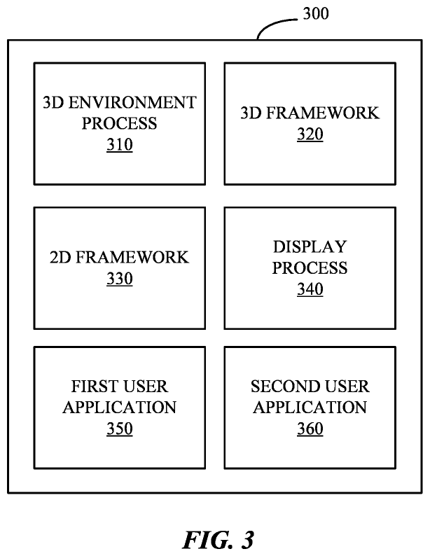

FIG. 3 is a block diagram illustrating a computer system (e.g., computer system 300) in accordance with some examples. Not all of the illustrated components are used in all examples; however, one or more examples can include additional and/or different components than those shown in FIG. 3. In some examples, computer system 300 includes one or more components described above with respect to electronic device 105, handheld electronic device 104, electronic device 110, electronic device 115, and/or server 120 as shown in FIG. 1. Variations in the arrangement and type of the components can be made without departing from the spirit or scope of the claims as set forth herein. Additional components, different components, and/or fewer components can be used as well.

In some examples, computer system 300 loads, renders, manages, and/or displays computer-generated content in a 3D environment. The 3D environment can be either virtual or physical, with the computer-generated content either completely covering a field of view of a user or supplementing the field of view. For example, computer system 300 can cause a virtual environment to be rendered and displayed to a user such that the user is provided content that is reactive to movements of the user. When the user moves around and performs different gestures, computer system 300 detects and processes the actions to provide tailored information to applications executing on computer system 300.

As illustrated in FIG. 3, computer system 300 includes 3D environment process 310, 3D framework 320 (e.g., a 3D UI framework and/or other type of 3D framework), 2D framework 330 (e.g., a 2D UI framework and/or other type of 2D framework), display process 340, first user application 350, and second user application 360. While FIG. 3 illustrates that each of these components are on a single computer system, it should be recognized that one or more components can be on another computer system in communication (e.g., wired and/or wireless communication) with computer system 300. In addition, while each component will be discussed separately, in some examples, the functionality of one or more components are combined together or separated further. In some examples, one or more components of computer system 300 communicate with other components via application programming interfaces (APIs), inter-process communications (IPCs), and/or serial peripheral interfaces (SPIs).

In some examples, 3D environment process 310 executes as a background process (e.g., a daemon, a service, a system process, an application process, and/or one or more instructions) to manage a 3D environment on behalf of one or more applications (e.g., first user application 350 and/or second user application 360). For example, 3D environment process 310 can create the 3D environment, manage a state of the 3D environment, receive requests from the one or more applications to render content in the 3D environment, communicate with 3D framework 320 and/or 2D framework 330 to service the requests, cause display process 340 to display the 3D environment, and/or detect and process inputs from a number of different sources.

In some examples, 3D environment process 310 provides and/or uses (e.g., implements and/or communicates via) one or more APIs to be used by the one or more applications for setting up the 3D environment. In such examples, the APIs can work in a declarative form that allows for developers to create views, UI objects, animations, and/or other user-interface elements without needing to configure the 3D environment imperatively. In some examples, 3D environment process 310 creates a scene via a scene graph, adds one or more entities to the scene, and/or causes the scene to be rendered.

In some examples, 3D environment process 310 combines functionality of 3D framework 320 and 2D framework 330 such that user-interface elements and/or functionality provided by 3D framework 320 and/or 2D framework 330 can be used with each other rather than requiring one or the other to be used at a time. For example, 3D environment process 310 acts as a bridge between 3D framework 320 and 2D framework 330, providing each the ability to render objects together in a single scene. In some examples, 3D framework 320 renders 3D objects (e.g., via a first render server) and manages interactions with respect to the 3D objects and/or other objects. Similarly, 2D framework renders 2D objects (e.g., via a second render server different from the first render server) (e.g., and not 3D objects) and manages interactions with respect to the 2D objects and/or other objects. Rather than requiring each framework to work independently, such as providing a separate space for each to own, techniques described herein provide a single space that combines functionality of 3D framework 320 and 2D framework 330 to create the 3D environment. For example, as further discussed below, 2D environment can render objects to be used by 3D framework 320 when rendering the 3D environment.

In some examples, to perform such functionality described above, 3D environment process 310 creates a view (e.g., sometimes referred to as a world view) of a 3D environment and adds one or more 3D objects to the view. In such examples, an object of the one or more objects can be hidden, as described further below. In some examples, the object can be used by 3D framework 320 to maintain a place for 2D content from 2D framework 320. In such examples, one technique for implementing such is via a scene graph. The scene graph can include multiple 3D entities that are managed by environment process 310 and/or 3D framework 320. Such 3D entities can include both visible entities and hidden entities. In some examples, a hidden entity (e.g., sometimes referred to as an invisible and/or non-displayed entity) has a size, position, and/or orientation within the 3D environment. Moreover, the hidden entity is connected to a 2D entity such that 3D framework 320 communicates with 2D framework via the hidden entity and/or vice versa.

In some examples, to perform such functionality described above, 3D environment process 310 creates a view of a 3D environment and adds one or more 3D objects to the view based on one or more requests from a user application (e.g., first user application 350). Such requests can include requests to place one or more objects (sometimes referred to herein as user interface (UI) objects) within the 3D environment. In some examples, the UI objects are 2D and/or 3D UI objects. In some examples, the user application requests to place objects within the view to 3D environment process 310 (e.g., and/or another process, such as a system process, that manages the 3D environment). For example, in a scenario in which 3D environment process 310 is managing views of the environment, a user application might not have directly control of placing objects within the environment. In some examples, the user process provides requests (e.g., declarative requests) to 3D environment process 310 to request placement of objects within the 3D environment. Such requests can include one or more features (e.g., parameters, types, properties, characteristics, and/or behaviors) corresponding to the UI object. In some examples, some (e.g., and/or all) of the request is treated a declarative request (e.g., not an imperative request). In some examples, the request is provided (e.g., transmitted, sent, and/or submitted) via an API call (e.g., as described above) from one process to another (e.g., from the user application process to a system process such as 3D environment process 310 or a system process in communication therewith).

In some examples, 3D environment process 310 receives and parses the request. In some examples, 3D environment process 310 processes the request and makes a determination of whether to place the object within the 3D environment. In some examples, 3D environment process 310 processes the request and makes a determination of how to place the object within the 3D environment. In some examples, the determination can be performed using one or more pieces of data related to the request, the UI object, and/or the user application. For example, 3D environment process 310 determines whether a requested size of the UI object satisfies a set of size criteria. For further example, 3D environment process 310 determines whether a requested location of the UI object satisfies a set of location criteria (e.g., satisfies a maximum distance criterion and/or does not conflict with existing UI objects). In some examples, the determination of how to place the object within the 3D environment includes determining one or more features of the UI object that is placed within the 3D environment. For example, 3D environment process 310 determine one or more of: size, location, distance from application, appearance, and/or how the UI object interacts with other objects in the environment. In some examples, the one or more features determined by 3D environment process 310 are different than features specified in the request to place the object received from the user application. For example, a request processed as a declarative request can mean that 3D environment process can override requested features with other features and/or values. For further example, a request processed as a declarative request can mean that 3D environment process can apply default and/or different features to the UI object than what is specified in the request (e.g., the request does not declare a feature and/or declares a different feature). For example, in the case of and a request to place an object at a non-permitted location (e.g., outside designated spatial bounds), 3D environment process can determine a permitted location that is a different location, and cause the UI object to be placed at the permitted location (e.g., rather than fail and/or return an error to the user application).

In some examples, a user application (e.g., first user application 350 and/or second user application 360) is subject to a one or more spatial bounds (e.g., 2D, 3D, and/or along one or more individual axes). For example, first user application 350 (e.g., and/or one or more other user applications) can cause one or more UI objects (e.g., windows that include content, dialog boxes, menus, sliders, toolbars, and/or other intractable and/or informational elements) to be displayed in a multi-application environment (e.g., an environment in which multiple applications can present visual output). In some examples, this multi-application environment is managed by one or more system processes (e.g., such as 3D environment process 310 and/or display process 340, referred to interchangeably herein for the purposes of managing requests for placement of UI objects unless otherwise noted). For example, spatial bounds within the environment can allow user applications to display content without excessive interference to and/or by other applications. In some examples, the spatial bounds corresponding to each application are enforced by the system process. For example, first user application can submit a request to place a UI object outside of the spatial bounds, and typically such requests are not successful due to being outside of the spatial bounds (e.g., outside of a permitted area and/or location).

In some examples, computer system 300 can allow a request to place a UI object outside of first user application 350's spatial bounds to be successful. For example, 3D environment process 310 can (e.g., under certain circumstances) allow UI objects to exceed the application's designated spatial bounds. In some examples, computer system 300 permits placement of a UI object outside of (e.g., partially or wholly) the spatial bounds if the UI object corresponds to a predefined type of object (e.g., an out-of-bounds UI object, also referred to herein as an OOB UI object). For example, a request to place a UI object outside of the spatial bounds can be successful if the requested UI object is designed as a certain type (e.g., in the request) (e.g., a predefined class of UI objects, having a specified predefined property, using a specific API call for such objects, and/or otherwise identified as including and/or corresponding to the certain type). In some examples, UI objects permitted to be placed outside of the spatial bounds are subject to one or more conditions (e.g., constraints, rules, and/or policies) (e.g., other than being the certain type). In some examples, the one or more conditions include one or more conditions related to: distance of the UI object (e.g., from the application's spatial bounds, from another application and/or process's spatial bonds), size of the UI object (e.g., a maximum size), position of the UI object (e.g., cannot be placed in a location that obscures a portion of another application (e.g., from a viewpoint and/or in a viewport for the user)), behavior of the UI object (e.g., how and/or whether it moves and/or animates, how and/or whether it response to user interaction, and/or how it interacts with other UI objects, system events, and/or system states), visual appearance of the UI object (e.g., which can include size and/or other characteristics such as opacity, coloring, and/or fonts), and/or under what conditions the UI object is displayed (e.g., when a certain view is displayed, but not when that certain view is not displayed). Below are several techniques and/or processes that provide additional explanation regarding the permissive placement of content outside of the spatial bounds of an application.

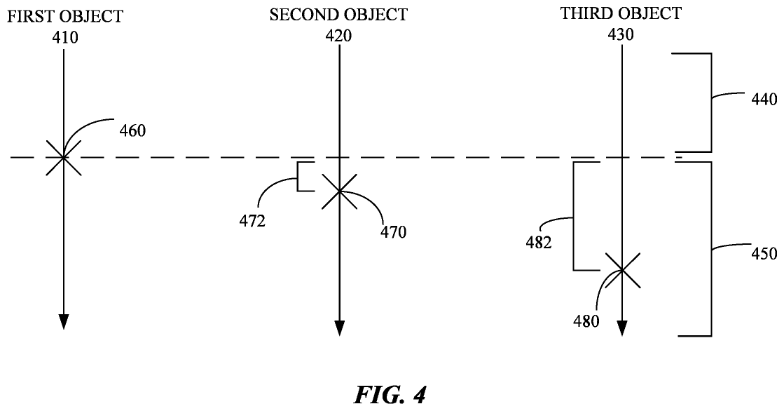

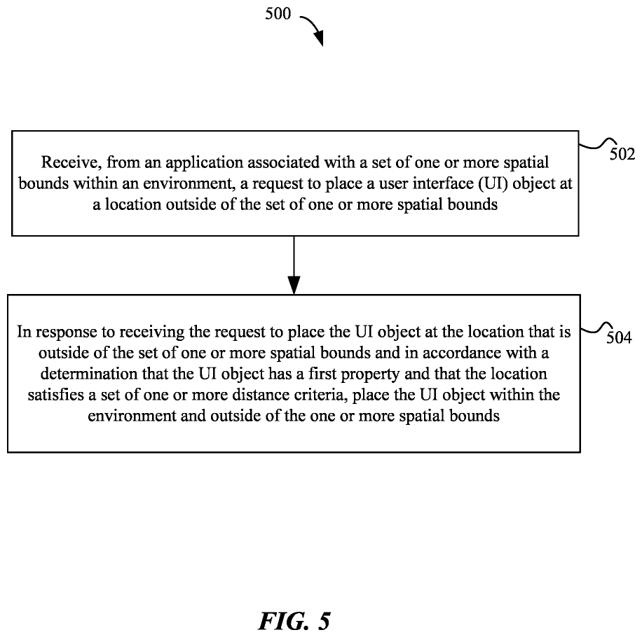

FIG. 4 illustrate example scenarios that reflect placement of user interface objects within an environment in accordance with some examples. The scenarios and interfaces illustrated in these figures are used to illustrate the processes described below including the processes in FIG. 5.

FIG. 4 illustrates different distance scales for UI objects (e.g., of different types) from an application (e.g., a spatial bound provided to the application for the application to place content). In this example, three UI objects (e.g., first object 410, second object 420, and third object 430) are associated with three different limits on a maximum distance that the respective object can be placed from a spatial bound (e.g., boundary) of the application. In this example, space 440 above the dotted line is within spatial bound of the application and below the dotted line is space 450 which is outside of the spatial bound of the application. The X's in FIG. 4 are used to show limits (e.g., limit 460, limit 470, and limit 480) on a scale for each respective UI object of first object 410, second object 420, and third object 430. In this example, the X for first object 410 indicates that first object 410 is not allowed pass (e.g., be placed at a location outside of and/or move to be outside of) the spatial bound of the application (e.g., limit 460 is on the spatial bound). Standing in contrast, FIG. 4 illustrates the X for third object 430 (e.g., a particular type of UI object permitted to exceed the spatial bound of the application) indicates that it can be placed outside the spatial bound (e.g., by a maximum distance 482) up to limit 480. Second object 430 is allowed to exceed the spatial bound, but not by as much as third object 430, which can be due to the size and/or other features of second object 420. As illustrated in FIG. 4, second object 420 is permitted to be placed at a location that exceeds the spatial bound, up to limit 470, by a distance 472.

FIG. 5 is a flow diagram illustrating a method (e.g., method 500) for managing a request for placement of a UI object in accordance with some examples. Some operations in method 500 are, optionally, combined, the orders of some operations are, optionally, changed, and some operations are, optionally, omitted.

As described below, method 500 provides an intuitive way for managing a request for placement of a UI object. Method 500 reduces the cognitive burden on a user for placing a UI object, thereby creating a more efficient human-machine interface. For battery-operated computing devices, enabling a user to place a UI object faster and more efficiently conserves power and increases the time between battery charges.

At 502, the computer system (e.g., 300) (e.g., and/or a system process of the computer system, such as 310 and/or 340) receives (e.g., via an application programming interface (API)), from an application (e.g., 350) (e.g., a user application and/or an application installed on the computer system (e.g., by a user and/or another computer system)) (e.g., of a computer system (e.g., a device, a personal device, a user device, and/or a head-mounted display (HMD))) associated with a set of one or more spatial bounds (e.g., the dotted line in FIG. 4) (e.g., defining a two-dimensional (2D) area (e.g., of a 2D or 3D environment) and/or a three-dimensional (3D) volume (e.g., of a 3D environment) within which the application is permitted to place user interface objects (e.g., a drawing area and/or scene bounds) (e.g., without conditions and/or under a reduced set of conditions as compared to outside of the set of one or more spatial bounds)) within an environment (e.g., 2D and/or 3D environment), a request to place a user interface (UI) object (e.g., 410, 420, 430, and/or 604) (e.g., a visible or non-visible object) at a location outside of the set of one or more spatial bounds. In some examples, a request to place the UI object is a request to add, create, generate, move, render, display, and/or cause display of the UI object. In some examples, the computer system is a phone, a watch, a tablet, a fitness tracking device, a wearable device, a television, a multi-media device, an accessory, a speaker, and/or a personal computing device. In some examples, the computer system is in communication with input/output devices, such as one or more cameras (e.g., a telephoto camera, a wide-angle camera, and/or an ultra-wide-angle camera), speakers, microphones, sensors (e.g., heart rate sensor, monitors, antennas (e.g., using Bluetooth and/or Wi-Fi), fitness tracking devices (e.g., a smart watch and/or a smart ring), and/or near-field communication sensors). In some examples, the computer system is in communication with a display generation component (e.g., a projector, a display, a display screen, a touch-sensitive display, and/or a transparent display). In some examples, receiving the request to place the UI object includes detecting, via one or more input devices in communication with the computer system, an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location).

At 504, in response to receiving the request to place the UI object (e.g., 410, 420, 430, and/or 604) at the location (e.g., the location specified in the request, in a different request or communication, and/or not specified in a request (e.g., a default location)) that is outside of the set of one or more spatial bounds (e.g., the dotted line in FIG. 4) (e.g., wholly, in part, or either) and in accordance with a determination that the UI object has a first property (e.g., declared and/or assigned a property in the request and/or requested using an API call, wherein the property and/or API call corresponds to UI objects that can be placed outside of spatial bounds of a corresponding application) and that the location satisfies a set of one or more distance criteria (e.g., 472 or 482) (e.g., does not exceed a maximum permissible distance from the location of the set of one or more spatial bounds) (e.g., is not too far from the application's drawing area), the computer system places (e.g., 300) (e.g., and/or a system process of the computer system, such as 310 and/or 340) the UI object within the environment and outside of the one or more spatial bounds. In some examples, placing the UI object includes one or more of: displaying, causing display of, rendering, and/or permitting display of, and/or enabling interaction (e.g., user interaction and/or interaction with other UI objects) with the UI object in the environment. In some examples, placing the UI object does not include displaying the UI object in the environment. In some examples, displaying the UI object includes displaying a graphical and/or visual representation of the UI object.

In some examples, in response to receiving the request to place the UI object (e.g., 410, 420, 430, and/or 604) at the location that is outside of the set of one or more spatial bounds and in accordance with a determination that the UI object has a second property different from the first property (e.g., irrespective and/or regardless of whether the location satisfies the set of one or more distance criteria) (e.g., and that the location satisfies the set of one or more distance criteria), the computer system forgoes placing the UI object within the environment and outside of the one or more spatial bounds. In some examples, in response to receiving the request to place the UI object at the location that is outside of the set of one or more spatial bounds and in accordance with a determination that the UI object has a second property (e.g., declared and/or assigned a property in the request and/or requested using an API call, wherein the property and/or API call corresponds to UI objects that are placed within spatial bounds of a corresponding application) different from the first property, placing the UI object within the environment and within the one or more spatial bounds.

In some examples, while the computer system (e.g., 300) displays the UI object (e.g., 410, 420, 430, and/or 604) in the environment, the computer system receives an indication of an interaction (e.g., an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location) corresponding to, data corresponding to, and/or a call via one or more APIs) (e.g., a collision with another UI object, an influence by another UI object, and/or other type of interaction) (e.g., detected via a computation, determination, and/or one or more input devices (e.g., a camera (e.g., a telephoto camera, a wide-angle camera, and/or an ultra-wide-angle camera), a microphone, a sensor (e.g., a heart rate sensor and/or a motion sensor), a touch-sensitive surface, a mouse, a keyboard, a touch pad, and/or an input mechanism (e.g., a physical input mechanism, such as a rotatable input mechanism and/or a button))) corresponding to (e.g., with respect to, affecting, associated with, and/or directed to) a respective location that is outside of the one or more spatial bounds (e.g., the dotted line in FIG. 4). In some examples, in response to receiving the interaction and in accordance with a determination that the respective location corresponds to a location of the UI object, the computer system sends, to the application (e.g., 350), an indication of the interaction (e.g., an effect of the interaction (e.g., a change in location, orientation, and/or mode), information about the interaction, a type of input that the interaction corresponds to, and/or one or more movement characteristics of the interaction).

In some examples, the request to place the UI object is received by a system process (e.g., 310 and/or 340)) (e.g., a daemon a service, and/or other type of system process) of a computer system (e.g., 300) (e.g., a device, a personal device, a user device, and/or a head-mounted display (HMD)). In some examples, the computer system is executing the application. In some examples, the computer system is not executing the application.

In some examples, the UI object (e.g., 410, 420, 430, and/or 604) includes a plurality of controls. In some examples, a respective control of the plurality of controls is configured to, when selected, cause one or more computer systems (and/or one or more applications) to perform an operation with respect to the application (e.g., 350). In some examples, each control of the plurality of controls is configured to, when selected, cause one or more computer systems to perform a different operation with respect to the application. In some examples, an input directed to the plurality of controls is processed by the application. In some examples, the UI object is a toolbar, a color picker, and/or a menu. In some examples, a UI object is referred to as a UI element.

In some examples, the UI object (e.g., 410, 420, 430, and/or 604) includes one or more characteristics (e.g., visual, orientation, and/or location characteristics) (e.g., one or more default characteristics) (e.g., a default appearance and/or anchoring positions with respect to the one or more spatial bounds) (e.g., a default distance in a direction toward and/or away from a user and/or a view of a user). In some examples, placing the UI object includes, in accordance with a determination that the one or more characteristics are not specified by the request to place the UI object, applying one or more default characteristics to the UI object. In some examples, placing the UI object includes, in accordance with a determination that the one or more characteristics are specified by the request to place the UI object, applying the one or more characteristics to the UI object (and/or determining whether the one or more characteristics satisfy a set of one or more criteria (e.g., distance, size, and/or z-offset)).

In some examples, the request to place the UI object (e.g., 410, 420, 430, and/or 604) includes a size (e.g., a size category and/or one or more size measurements) for the UI object.

In some examples, the UI object (e.g., 410, 420, 430, and/or 604) is displayed, in accordance with a determination that the size satisfies a first set of one or more size criteria (e.g., defined for the UI object, the application, the one or more spatial bounds, the location, and/or the environment) (e.g., a size maximum and/or a size minimum), in (e.g., at and/or as) the size; and in some examples, placing the UI object includes placing a representation of the size in accordance with a determination that the size satisfies the first set of one or more size criteria. In some examples, the UI object (e.g., 410, 420, 430, and/or 604) is displayed, in accordance with a determination that the size does not satisfy the first set of one or more size criteria (e.g., the size is too big or too small generally and/or for the application, the one or more spatial bounds, the location, and/or the environment), in a second size different from the size (e.g., a larger or smaller size). In some examples, placing the UI object includes placing a representation of the second size in accordance with a determination that the size does not satisfy the first set of one or more size criteria.

In some examples, the request to place the UI object (e.g., 410, 420, 430, and/or 604) includes a specified location (e.g., a particular location (e.g., relative to a virtual environment, a viewport, and/or to a spatial bound of the application)) for the UI object.

In some examples, while the computer system (e.g., 300) displays the UI object (e.g., 410, 420, 430, and/or 604) in the environment, the computer system receives an indication of an interaction (e.g., an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location) corresponding to, data corresponding to, and/or a call via one or more APIs) (e.g., a collision with another UI object, an influence by another UI object, and/or other type of interaction) (e.g., detected via a computation, determination, and/or one or more input devices (e.g., a camera (e.g., a telephoto camera, a wide-angle camera, and/or an ultra-wide-angle camera), a microphone, a sensor (e.g., a heart rate sensor and/or a motion sensor), a touch-sensitive surface, a mouse, a keyboard, a touch pad, and/or an input mechanism (e.g., a physical input mechanism, such as a rotatable input mechanism and/or a button))) corresponding to (e.g., with respect to, affecting, associated with, and/or directed to) a respective location that is outside of the one or more spatial bounds. In some examples, in response to receiving the interaction and in accordance with a determination that the respective location corresponds to a location of the UI object, the computer system sends, to the application, an indication of the interaction (e.g., an effect of the interaction (e.g., a change in location, orientation, and/or mode), information about the interaction, a type of input that the interaction corresponds to, and/or one or more movement characteristics of the interaction).

In some examples, the computer system (e.g., 300) displays the UI object (e.g., 410, 420, 430, and/or 604): in accordance with a determination that the size satisfies a first set of one or more size criteria (e.g., defined for the UI object, the application, the one or more spatial bounds, the location, and/or the environment) (e.g., a size maximum and/or a size minimum), in (e.g., at and/or as) the size; and in some examples, placing the UI object includes placing a representation of the size in accordance with a determination that the size satisfies the first set of one or more size criteria. in accordance with a determination that the size does not satisfy the first set of one or more size criteria (e.g., the size is too big or too small generally and/or for the application, the one or more spatial bounds, the location, and/or the environment), in a second size different from the size (e.g., a larger or smaller size). In some examples, placing the UI object includes placing a representation of the second size in accordance with a determination that the size does not satisfy the first set of one or more size criteria.

In some examples the computer system (e.g., 300) displays the UI object (e.g., 410, 420, 430, and/or 604): in accordance with a determination that the specified location satisfies the set of one or more distance criteria (e.g., defined for the UI object, the application, the one or more spatial bounds, the location, and/or the environment) (e.g., a distance maximum and/or a distance minimum), at (e.g., at and/or as) the specified location (e.g., outside of the one or more spatial bounds); and in some examples placing the UI object includes placing a representation of the UI object at the specified location in accordance with a determination that the specified location satisfies the set of one or more distance criteria. in accordance with a determination that the specified location does not satisfy the set of one or more distance criteria (e.g., the distance is too far or too close generally and/or for the application, a size of the one or more spatial bounds, and/or the environment), at a second location different from the specified location (e.g., outside of the one or more spatial bounds). In some examples, placing the UI object includes placing a representation of the UI object at the second location in accordance with a determination that the specified location does not satisfy the set of one or more distance criteria.

In some examples, the UI object (e.g., 410, 420, 430, and/or 604) corresponds to a view of the application (e.g., 350). In some examples, the UI object ceases to be displayed in conjunction with (e.g., before, when, after, and/or in response to) the view ceasing to be displayed.

In some examples, the UI object (e.g., 410, 420, 430, and/or 604) changes from a first visual appearance to a second visual appearance different from the first visual appearance in conjunction with the application becoming a background process (e.g., transitioning from a foreground process to a background process). In some examples, the second visual appearance is darker than the first visual appearance. In some examples, the second visual appearance is deemphasized relative to the first visual appearance. In some examples, the second visual appearance is not visible in the environment while the first visual appearance is visible in the environment.

In some examples, the UI object (e.g., 410, 420, 430, and/or 604) changes from a third visual appearance to a fourth visual appearance different from the third visual appearance in conjunction with (e.g., before, when, after, while, and/or in response to) a user interface element (e.g., a system menu, one or more system controls that, when selected, causes the computer system to change one or more system settings, such as volume, Wi-Fi connection, battery operating mode (e.g., lower powered battery operating mode, higher powered battery operating mode, screen brightness, and/or Bluetooth connection)) corresponding to a system process (e.g., 310 and/or 340) being displayed. In some examples, the fourth visual appearance is darker than the third visual appearance. In some examples, the fourth visual appearance is not visible in the environment while the third visual appearance is visible in the environment.

In some examples, after placing the UI object (e.g., 410, 420, 430, and/or 604) in the environment, the computer system (e.g., 300) receives a request to move the set of one or more spatial bounds within the environment. In some examples, receiving the request to move the set of one or more spatial bounds (e.g., the dotted line in FIG. 4) within the environment includes detecting, via one or more input devices in communication with the computer system, an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location). In some examples, in response to receiving the request to move the set of one or more spatial bounds within the environment, the computer system causes (e.g., moves and/or sends an indication with an updated location) the UI object to move from a first location to a second location within the environment (e.g., the UI object is anchored to the set of one or more spatial bounds within the environment), wherein the second location is different from the first location. In some examples, the first location corresponds to a location that the UI object is placed in response to receiving the request to place the UI object at the location that is outside of the set of one or more spatial bounds. In some examples, the second location is the same distance and/or orientation from the set of one or more spatial bounds after the set of one or more spatial bounds is moved as the first location was from the set of one or more spatial bounds before the set of one or more spatial bounds is moved. In some examples, the UI object is anchored to a location. In some examples, the anchor is displayed while the UI object is displayed. In some examples, the anchor is selected, where selection of the anchor element causes the UI object to be displayed.

Note that details of the processes described above with respect to method 500 (e.g., FIG. 5) are also applicable in an analogous manner to other methods described herein, including methods 700, 800, and/or 900. For example, method 700 optionally includes one or more of the characteristics of the various methods described above with reference to method 500. For example, the request of method 500 can be the request of method 700. For brevity, these details are not repeated below.

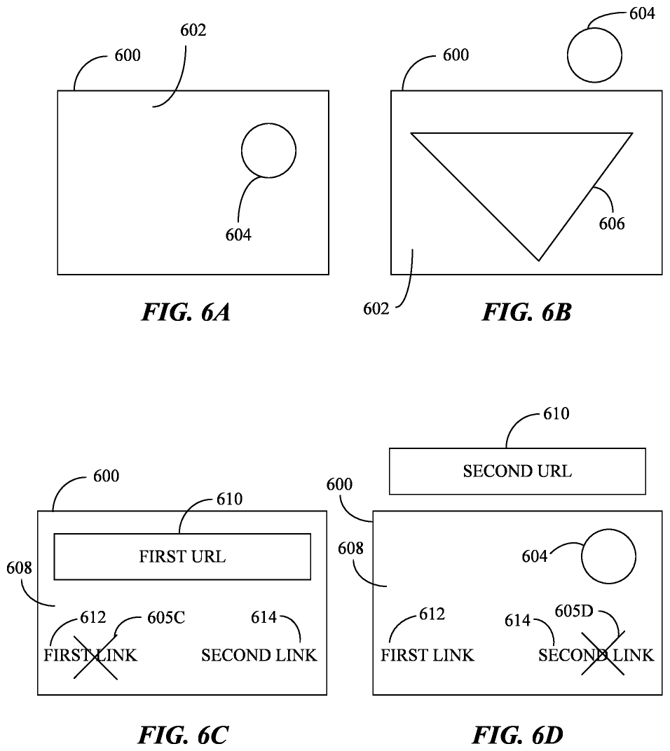

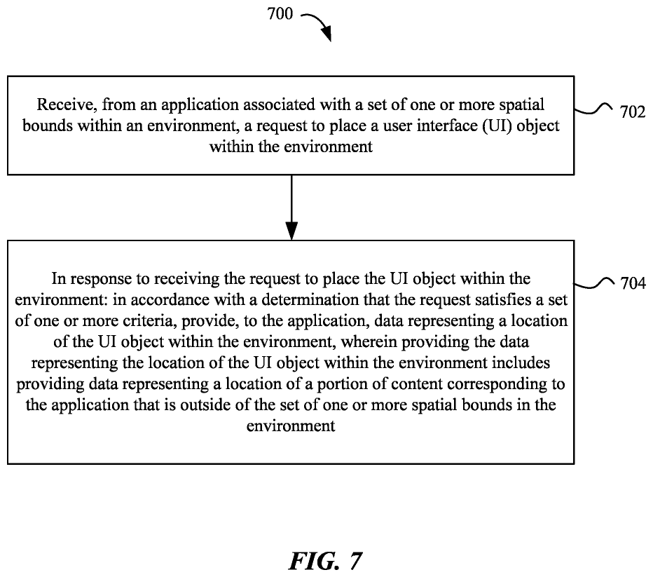

FIGS. 6A-6D illustrate example scenarios that reflect placement of user interface objects within an environment in accordance with some examples. The scenarios and interfaces illustrated in these figures are used to illustrate the processes described below including the processes in FIG. 7.

FIGS. 6A-6B illustrate a computer system (e.g., computer system 300) displaying content of first user interface 602 within spatial bound 600. FIGS. 6A-6B also illustrate a display (e.g., displayed by and/or caused to be displayed by computer system 300) of UI object 604. In some examples, UI object 604 is an extension of first user interface 602 and has the default appearance and/or positional characteristics of first user interface 602. In some examples, UI object 604 is a toolbar, palette, dialog box, menu, and/or text entry field. In some examples, computer system 300 receives an input/interaction corresponding to UI object 604, processes the input/interaction, and transmits the input/interaction to an application corresponding to first user interface 602. In some examples, UI object 604 has the default appearance of first user interface 602 including having the same color, transparency, border style, font, and/or icons. In some examples, UI object 604 has a default anchoring to a particular location of a view of the application, and/or z-offset. In some examples, computer system 300 receives an input requesting to change the size of UI object 604. In some examples, computer system 300 makes a determination of the minimum/maximum allowable size for UI object 604 based on criteria including size (e.g., size of spatial bound 600, virtual window, first user interface 602, application, content, and/or UI object 604), location (e.g., location of spatial bound 600, virtual window, first user interface 602, application, content, and/or UI object 604), and/or defaults (e.g., predefined defaults set for spatial bound 600, virtual window, first user interface 602, application, content, and/or UI object 604). In some examples, computer system 300 receives input requesting to change the location of UI object 604. In some examples, computer system 300 makes a determination to limit the allowable locations for UI object 604 based on criteria including size (e.g., size of spatial bound 600, virtual window, first user interface 602, application, content, and/or UI object 604), location (e.g., location of spatial bound 600, virtual window, first user interface 602, application, content, and/or UI object 604), defaults (e.g., predefined defaults set for spatial bound 600, virtual window, first user interface 602, application, content, and/or UI object 604), and/or distance (e.g., distance from spatial bound 600, virtual window, first user interface 602, application, and/or content). In some examples, UI object 604 is anchored to user interface 602 and moves when computer system 300 moves user interface 602.

FIG. 6A illustrates first user interface 602 (e.g., as displayed by a computer system (e.g., computer system 300)). In this example, first user interface 602 represents a user interface of an application executing on computer system 300. As illustrated in FIG. 6A, first user interface 602 is surrounded by spatial bound 600 representing a set of spatial bounds associated with the application of first user interface 602. In this example, UI object 604 is an object that corresponds to (e.g., created by) the application of first user interface 602, and is placed within the edges of spatial bound 600. In some examples, UI object 604 is placed within spatial bound 600 of user interface 602 because it is not of a particular type that is permitted to be placed outside of spatial bound 600 of user interface 602 (e.g., application requested it be placed outside of spatial bound 600 of user interface 602, which was not successful) (e.g., application requested it be placed within spatial bound 600 of user interface 602).

FIG. 6B illustrates user interface 602. As illustrated in FIG. 6B, user interface 602 includes content 606 (e.g., a UI object or other graphical object). FIG. 6B also illustrates UI object 604 placed outside of spatial bound 600. As explained in more detail below, there are several possible scenarios that result in UI object 604 being placed outside of spatial bound 600. In one example scenario, a system process that manages the environment receives a request to place UI object 604 within the environment and, in response, causes UI object to be placed outside of spatial bound 600. For example, 3D environment process 310 causes UI object to be place outside of spatial bound 600 so UI object 604 does not obscure content (e.g., content 606). In some examples, 3D environment process 310 causes UI object 604 to be placed outside of spatial bound 600 based on a request from the application of user interface 602. In some examples, the request to place UI object 604 does not designate it as a type of object that is permitted to be placed outside of spatial bound 600. For example, 3D environment process 310 causes UI object 604 to be place outside of spatial bound 600 despite the request not designating UI object 604 as the appropriate type of UI object. In such cases, 3D environment process 310 can automatically change the property of UI object 604 (e.g., to the permissive type) and/or can provide exception to the rule due to the determination to place UI object 604 outside due to a decision by 3D environment process 310. Another possible explanation for the scene in FIG. 6B is that the application requested to place content 606 (e.g., another UI object) at the location it is illustrated at in FIG. 6B. In such an example, 3D environment process 310 causes UI object 604 to be placed outside of spatial bound 600 so that it does not become obscured by content 606 (e.g., effectively increasing the usable area of the application). Yet another possible explanation for the scene in FIG. 6B is that the application requested to place content 606 at the location it is illustrated at in FIG. 6B. In such example, 3D environment process 310 causes UI object 604 to be placed outside of spatial bound 600 because the request was successful (e.g., satisfied certain criteria). In some examples, a system process (e.g., 3D environment process 310) places the object within the environment and/or provides information regarding the object's placement within the environment (e.g., location, features, and/or the like).

FIGS. 6C-6D illustrate computer system 300 displaying second user interface 608 of the application that is subject to spatial bound 600 (e.g., the same set of spatial bounds for the purposes of this example, though they could be different spatial bounds). Second user interface 608 can be content displayed in user interface 602 and/or a different view of the application corresponding to user interface 602. In this example, second user interface 608 includes first link 612 and second link 614, which are part of content caused to be displayed by the application (e.g., part of the application, such as a web browsing application, a game, and/or a productivity application) within the spatial bound 600.

At FIG. 6C, computer system 300 detects user gaze input 605C (e.g., represented by an X) at a location corresponding to first link 612. In response to detecting user gaze 605C, computer system 300 displays UI object 610 that includes a first URL that corresponds to (e.g., represents) the first link 612. In this example, UI object 610 includes dynamic content that is based on content that the user gaze input 605C is located on. In this example, computer system 300 follows (e.g., tracks location of and/or moves with) the gaze input (e.g., 605C) of a user and updates UI object 610 with content based on the location of the gaze. In some examples, UI object 610 moves based on the movement of gaze input 605C.

At FIG. 6C, computer system 300 is not displaying user interface 602 nor UI object 604. In some examples, computer system 300 ceases displaying UI object 604 when computer system 300 ceases displaying user interface 602 (e.g., a view that includes user interface 602). In some examples, computer system 300 fades out (e.g., darkens and/or disappears) UI object 604 when user interface 602 is in the background (e.g., when another application process and/or a system process has focus of computer system 300). In some examples, computer system 300 fades out UI object 604 when user interface 602 is in the foreground (e.g., in response to particular events and/or states of the application and/or the system). In some examples, UI object 610 is an object of a particular type that can be placed outside of spatial bounds 600.

FIG. 6D illustrates a scenario similar to FIG. 6C, but at a later time and with different content displayed by the application. At FIG. 6D, computer system 300 detects user gaze input 605D at a location corresponding to second link 614. In response to detecting user gaze 605D, computer system 300 displays UI object 610 that includes a second URL that corresponds to (e.g., represents) the second link 614. As illustrated in FIG. 6D, computer system 300 displays UI object 604 within the edges of spatial bound 600 (e.g., as described above with respect to FIG. 6A). At FIG. 6D, computer system 300 makes a determination that displaying UI object 610 within the edges of spatial bound 600 would cause UI object 604 to be obscured. As illustrated in FIG. 6D, because of the determination, computer system places UI object 610 at a location outside of spatial bound 600 (e.g., that is different than what is requested by the application, which requests that UI object 610 stay in close proximity to a location of gaze, such as the proximity shown in FIG. 6C). As illustrated in FIG. 6D, based on the determination, computer system 300 displays UI object 610 outside the spatial bound 600.

FIG. 7 is a flow diagram illustrating a method (e.g., method 700) for managing a request for placement of a UI object in accordance with some examples. Some operations in method 700 are, optionally, combined, the orders of some operations are, optionally, changed, and some operations are, optionally, omitted.

As described below, method 700 provides an intuitive way for managing a request for placement of a UI object. Method 700 reduces the cognitive burden on a user for placing a UI object, thereby creating a more efficient human-machine interface. For battery-operated computing devices, enabling a user to place a UI object faster and more efficiently conserves power and increases the time between battery charges.

At 702, the computer system (e.g., 300) receives (e.g., via an application programming interface (API)), from an application (e.g., 350) (e.g., a user application and/or an application installed on the computer system (e.g., by a user and/or another computer system)) (e.g., of a computer system (e.g., a device, a personal device, a user device, and/or a head-mounted display (HMD))) associated with a set of one or more spatial bounds (e.g., the dotted line in FIG. 4) (e.g., defining a two-dimensional (2D) area (e.g., of a 2D or 3D environment) and/or a three-dimensional (3D) volume (e.g., of a 3D environment) within which the application is permitted to place user interface objects (e.g., a drawing area and/or scene bounds) (e.g., without conditions and/or under a reduced set of conditions as compared to outside of the set of one or more spatial bounds)) within an environment (e.g., 2D and/or 3D environment), a request to place a user interface (UI) object (e.g., as described above with respect to method 500) within the environment (e.g., inside of the set of one or more spatial bounds, outside of the set of one or more spatial bounds, or both inside of and outside of (e.g., some portion inside and some portion outside)). In some examples, a request to place is a request to add, create, generate, move, render, display, and/or cause display of. In some examples, the requested location is explicitly included in the request (e.g., a set of coordinates, position, and/or other indication of location) and/or referenced in the request (e.g., a reference to an identifier of that can be used to determine the requested location). In some examples, the computer system is a phone, a watch, a tablet, a fitness tracking device, a wearable device, a television, a multi-media device, an accessory, a speaker, and/or a personal computing device. In some examples, the computer system is in communication with input/output devices, such as one or more cameras (e.g., a telephoto camera, a wide-angle camera, and/or an ultra-wide-angle camera), speakers, microphones, sensors (e.g., heart rate sensor, monitors, antennas (e.g., using Bluetooth and/or Wi-Fi), fitness tracking devices (e.g., a smart watch and/or a smart ring), and/or near-field communication sensors). In some examples, the computer system is in communication with a display generation component (e.g., a projector, a display, a display screen, a touch-sensitive display, and/or a transparent display). In some examples, receiving the request to place the UI object includes detecting, via one or more input devices in communication with the computer system, an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location).

At 704, in response to receiving the request to place the UI object (e.g., 410, 420, 430, and/or 604) within the environment, in accordance with a determination that the request (e.g., including the requested UI object) satisfies a set of one or more criteria (e.g., permitted type of object, permitting location, permitted distance, and/or does not cover application content and/or window chrome or covers by an acceptable amount), the computer system provides, to the application, data representing a location of the UI object within the environment (e.g., within the spatial bounds, outside of the spatial bounds, or both), wherein providing the data representing the location of the UI object within the environment includes providing data representing a location of at least a portion of content (e.g., the UI object, a portion of the application such as window chrome (e.g., a toolbar and/or other interactable portion of the window), and/or content from inside of the application window) corresponding to the application that is outside of the set of one or more spatial bounds (e.g., the dotted line in FIG. 4) in the environment. In some examples, in response to receiving the request to place the UI object within the environment and in accordance with a determination that the request satisfies the set of one or more criteria, a computer system places the UI object. In some examples, placing the UI object includes one or more of: displaying, causing display of, rendering, and/or permitting display of, and/or enabling interaction (e.g., user interaction and/or interaction with other UI objects) with the UI object in the environment. In some examples, placing the UI object does not include displaying the UI object in the environment. In some examples, displaying the UI object includes displaying a graphical and/or visual representation of the UI object.

In some examples, the request to place the UI object (e.g., 410, 420, 430, and/or 604) includes a specified location (e.g., a particular location (e.g., relative to a virtual environment, a viewport, and/or to a spatial bound of the application)) for the UI object.

In some examples, the data representing the location of the UI object (e.g., 410, 420, 430, and/or 604) within the environment does not represent the specified location included in the request (e.g., the location that the UI object is placed at differs from the from the specified location in the request).

In some examples, in accordance with a determination that content of the application is located at the specified location for the UI object (e.g., 410, 420, 430, and/or 604), the data representing the location of the user object within the environment does not represent the specified location for the UI object included in the request (e.g., the system automatically moves the location of the UI object to avoid overlaying to cover content of the application (e.g., and/or content of another application)). In some examples, the system determines that a location would cover content of the application (e.g., within the application spatial bounds), and automatically adjust the placement of the ornament to be outside of the application spatial bounds. In some examples, content continues to be at the specified location for the UI object after the data representing the location of the user object within the environment is sent. In some examples, in accordance with a determination that content of the application is located at the specified location for the UI object, providing the data representing the location of the UI object within the environment includes causing the UI object to be placed at a new location different from the specified location (e.g., the content of the application takes precedent over the UI object and the UI object is moved out of the way instead of (1) moving the content out of the way and/or (2) allowing the UI object to overlap and/or cover a portion of the content).

In some examples, in accordance with a determination that content of the application is located at the specified location for the UI object (e.g., 410, 420, 430, and/or 604) and in accordance with a determination that request does not satisfy the set of one or more criteria because the request does not specify a first property for the UI object (e.g., does not request that UI object is a type of object permitted to be placed outside of the application spatial bounds by an application (e.g., 350)), the computer system treats the first UI object as having (e.g., and/or changing the first UI object to have) the first property. In some examples, in accordance with a determination that content of the application is located at the specified location for the UI object (e.g., 410, 420, 430, and/or 604) and in accordance with a determination that request does not satisfy the set of one or more criteria because the request does not specify a first property for the UI object (e.g., does not request that UI object is a type of object permitted to be placed outside of the application's spatial bounds by an application (e.g., 350)), the computer system provides, to the application, data representing the location of the UI object within the environment (e.g., automatically change the property type to an object type permitted to be placed outside of the application spatial bounds by an application).

In some examples, the request to place the UI object (e.g., 410, 420, 430, and/or 604) within the environment includes a requested visual characteristic of the UI object (e.g., a custom size and/or appearance).

In some examples, in response to receiving the request to place the UI object (e.g., 410, 420, 430, and/or 604) within the environment, the computer system (e.g., 300) provides data representing a visual characteristic of the UI object, different from the requested visual characteristic of the UI object, without providing the requested visual characteristic of the UI object (e.g., the computer system chooses a different visual property for the UI object).

In some examples, the request to place the UI object (e.g., 410, 420, 430, and/or 604) within the environment includes a requested type of UI object (e.g., dialog box, toolbar, menu, and/or text entry field) to be provided. In some examples, the request specifies a type of UI object and does not need to provide further details regarding the visual characteristics of the UI object. For example, where the type of UI object has a standard and/or system default appearance. In some examples, the request specifies a type of UI object without specifying further visual characteristics of the UI object.

In some examples, in response to receiving the request to place the UI object (e.g., 410, 420, 430, and/or 604) within the environment, the computer system (e.g., 300) provides data representing a visual characteristic of the UI object, different from the requested visual characteristic of the UI object, without providing the requested visual characteristic of the UI object (e.g., the computer system chooses a different visual property for the UI object).

In some examples, after providing, to the application, data representing the location of the UI object (e.g., 410, 420, 430, and/or 604) within the environment and in accordance with a determination that the location of the UI object corresponds to a location of a first type of object, the first type of object is caused to be moved. In some examples, after providing, to the application, data representing the location of the UI object (e.g., 410, 420, 430, and/or 604) within the environment in accordance with a determination that the location of the UI object corresponds to a location of a second type of object, the second type of object is not caused to be moved. In some examples, the first type of object is window chrome of a user interface of the application (e.g., if the UI object is requested to and/or determined to be placed at a location that covers the chrome (e.g., an interactable portion and/or a toolbar) of a window, the system can automatically move chrome so at least a portion is located outside of a set of defined borders for the application (e.g., and place UI object at the location and provide that location to the application)).

In some examples, providing, to the application, data representing the location of the UI object (e.g., 410, 420, 430, and/or 604) within the environment causes the UI object to be displayed adjacent to (e.g., above, below, and/or on the side of) the content. In some examples, content of the UI object is adjusted in response to gaze being detected. In some examples, in response to a computer system detects one or more gaze inputs, the computer system displays updated content of the UI object (e.g., based on the location of the one or more gaze inputs). In some examples, the UI object is a uniform resource locator entry field, a text entry field, and/or an image. In some examples, the computer system provides a location for the UI object (e.g., a URL bar) above content being gazed at, detects a change in gaze, and in response, changes the content of the UI object based on the gaze (e.g., in relation to the content at the location of the gaze) (e.g., tracks and or moves with the location of the gaze). In some examples, in accordance with a determination that the gaze is detected at a first location, the content includes a first set of content. In some examples, in accordance with a determination that the gaze is detected at a second location different from the first, the content includes a second set of content different from the first set of content. In some examples, the first set of content includes content that is based on content at the first location and not the second location. In some examples, the second set of content includes content that is based on content at the second location and the first location.

In some examples, after receiving the request to place the UI object (e.g., 410, 420, 430, and/or 604) within the environment, the computer system receives a request to remove the UI object from the environment. In some examples, in response to detecting the request to remove the UI object from the environment, the computer system provides data to the application representing an updated location of the portion of content corresponding to the application that is outside of the set of one or more spatial bounds in the environment, wherein the portion of the content continues to be displayed after the data representing the updated location is provided (e.g., the application chrome moves back to being within the spatial bounds, but he UI object ceases to be displayed). In some examples, in response to detecting the request to remove the UI object from the environment, the computer system provides (e.g., to the application) data the causes the UI object to be removed from the environment.

In some examples, while the UI object is within the environment (e.g., placed and/or displayed), the computer system receives an indication of an interaction (e.g., an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location) corresponding to, data corresponding to, and/or a call via one or more APIs), a collision with another UI object, an influence by another UI object, and/or other type of interaction) (e.g., detected via a computation, determination, and/or one or more input devices (e.g., a camera (e.g., a telephoto camera, a wide-angle camera, and/or an ultra-wide-angle camera), a microphone, a sensor (e.g., a heart rate sensor and/or a motion sensor), a touch-sensitive surface, a mouse, a keyboard, a touch pad, and/or an input mechanism (e.g., a physical input mechanism, such as a rotatable input mechanism and/or a button)) corresponding to (e.g., with respect to, affecting, associated with, and/or directed to) a respective location that is outside of the one or more spatial bounds. In some examples, in response to receiving the interaction and in accordance with a determination that the respective location corresponds to a location of the at least a portion of content corresponding to the application that is outside of the set of one or more spatial bounds in the environment, the computer system sends, to the application, an indication of the interaction (e.g., an effect of the interaction (e.g., a change in location, orientation, and/or mode), information about the interaction, a type of input that the interaction corresponds to, and/or one or more movement characteristics of the interaction).

In some examples, the request is received by a system process (e.g., 310 and/or 340) (e.g., a daemon, a service, and/or other type of system process) (e.g., a process of an operating system, an application process and/or a process managing the application).

Note that details of the processes described above with respect to method 700 (e.g., FIG. 7) are also applicable in an analogous manner to other methods described herein, including methods 500, 800, and/or 900. For example, method 500 optionally includes one or more of the characteristics of the various methods described above with reference to method 700. For example, the request of method 500 can be the request of method 700. For brevity, these details are not repeated below.

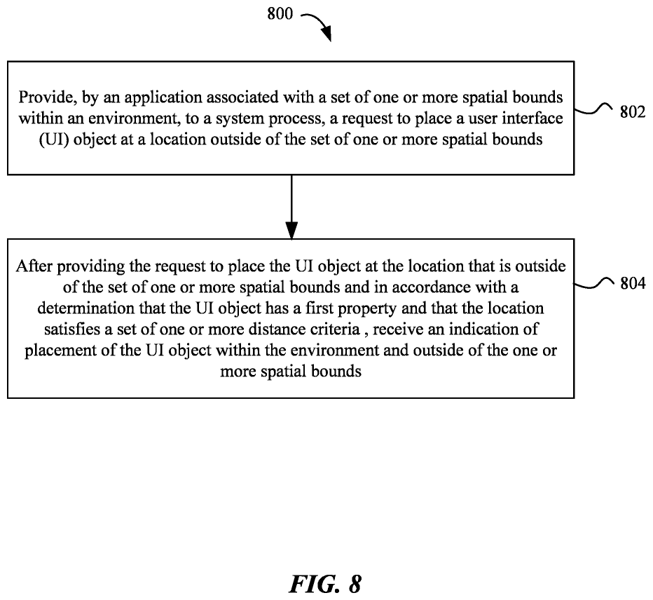

FIG. 8 is a flow diagram illustrating a method (e.g., method 800) for requesting placement of a UI object in accordance with some examples. Some operations in method 800 are, optionally, combined, the orders of some operations are, optionally, changed, and some operations are, optionally, omitted.

As described below, method 800 provides an intuitive way for requesting placement of a UI object. Method 800 reduces the cognitive burden on a user for requesting placement of a UI object, thereby creating a more efficient human-machine interface. For battery-operated computing devices, enabling a user to request placement of a UI object faster and more efficiently conserves power and increases the time between battery charges.

At 802, the computer system (e.g., 300) provides (e.g., via an application programming interface (API)), by an application (e.g., 350) associated with a set of one or more spatial bounds (e.g., the dotted line in FIG. 4) (e.g., defining a two-dimensional (2D) area (e.g., of a 2D or 3D environment) and/or a three-dimensional (3D) volume (e.g., of a 3D environment) within which the application is permitted to place user interface objects (e.g., a drawing area and/or scene bounds) (e.g., without conditions and/or under a reduced set of conditions as compared to outside of the set of one or more spatial bounds)) within an environment (e.g., 2D and/or 3D environment) (e.g., by an application), to a system process (e.g., 310 and/or 340), (e.g., a user application and/or an application installed on the computer system (e.g., by a user and/or another computer system)) (e.g., of a computer system (e.g., a device, a personal device, a user device, and/or a head-mounted display (HMD))), a request to place a user interface (UI) object (e.g., a visible or non-visible object) at a location outside of the set of one or more spatial bounds. In some examples, a request to place the UI object is a request to add, create, generate, move, render, display, and/or cause display of the UI object. In some examples, the computer system is a smart phone, a watch, a tablet, a fitness tracking device, a wearable device, a television, a multi-media device, an accessory, a speaker, and/or a personal computing device. In some examples, the computer system is in communication with input/output devices, such as one or more cameras (e.g., a telephoto camera, a wide-angle camera, and/or an ultra-wide-angle camera), speakers, microphones, sensors (e.g., heart rate sensor, monitors, antennas (e.g., using Bluetooth and/or Wi-Fi), fitness tracking devices (e.g., a smart watch and/or a smart ring), and/or near-field communication sensors). In some examples, the computer system is in communication with a display generation component (e.g., a projector, a display, a display screen, a touch-sensitive display, and/or a transparent display). In some examples, receiving the request to place the UI object includes detecting, via one or more input devices in communication with the computer system, an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location).

At 804, after providing the request to place the UI object (e.g., 410, 420, 430, and/or 604) at the location (e.g., the location specified in the request, in a different request or communication, and/or not specified in a request (e.g., a default location)) that is outside of the set of one or more spatial bounds (e.g., the dotted line in FIG. 4) (e.g., wholly, in part, or either) and in accordance with a determination that the UI object has a first property (e.g., declared and/or assigned a property in the request and/or requested using an API call, wherein the property and/or API call corresponds to UI objects that can be placed outside of spatial bounds of a corresponding application) and that the location satisfies a set of one or more distance criteria (e.g., 472 or 482) (e.g., does not exceed a maximum permissible distance from the location of the set of one or more spatial bounds) (e.g., is not too far from the application's drawing area), the computer system receives an indication of placement of the UI object within the environment and outside of the one or more spatial bounds. In some examples, placing the UI object includes one or more of: displaying, causing display of, rendering, and/or permitting display of, and/or enabling interaction (e.g., user interaction and/or interaction with other UI objects) with the UI object in the environment. In some examples, placing the UI object does not include displaying the UI object in the environment. In some examples, displaying the UI object includes displaying a graphical and/or visual representation of the UI object.

Note that details of the processes described above with respect to method 800 (e.g., FIG. 8) are also applicable in an analogous manner to other methods described herein, including methods 500, 700, and/or 900. For example, method 900 optionally includes one or more of the characteristics of the various methods described above with reference to method 700. For example, the request of method 800 can be the request of method 900. For brevity, these details are not repeated below.

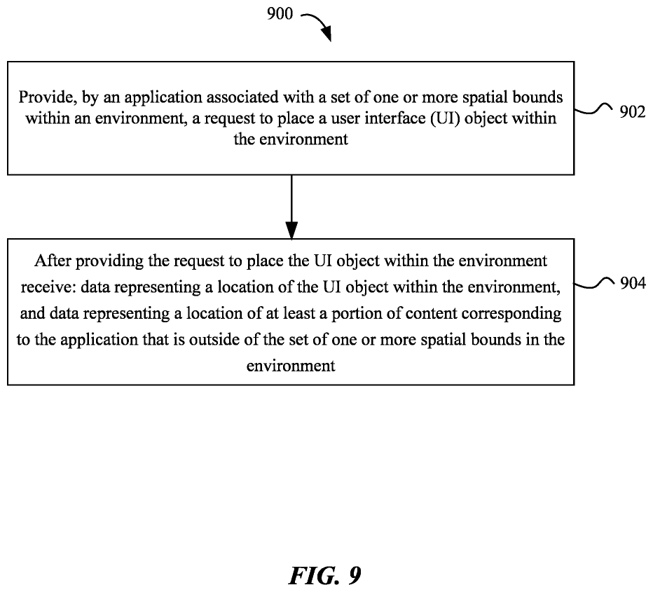

FIG. 9 is a flow diagram illustrating a method (e.g., method 900) for requesting placement of a UI object in accordance with some examples. Some operations in method 900 are, optionally, combined, the orders of some operations are, optionally, changed, and some operations are, optionally, omitted.

As described below, method 900 provides an intuitive way for requesting placement of a UI object. Method 900 reduces the cognitive burden on a user for requesting placement of a UI object, thereby creating a more efficient human-machine interface. For battery-operated computing devices, enabling a user to request placement of a UI object faster and more efficiently conserves power and increases the time between battery charges.

At 902, the computer system (e.g., 300) provides (e.g., via an application programming interface (API)), by an application (e.g., 350) (e.g., a user application and/or an application installed on the computer system (e.g., by a user and/or another computer system)) (e.g., of a computer system (e.g., a device, a personal device, a user device, and/or a head-mounted display (HMD))) associated with a set of one or more spatial bounds (e.g., the dotted line in FIG. 4) (e.g., defining a two-dimensional (2D) area (e.g., of a 2D or 3D environment) and/or a three-dimensional (3D) volume (e.g., of a 3D environment) within which the application is permitted to place user interface objects (e.g., a drawing area and/or scene bounds) (e.g., without conditions and/or under a reduced set of conditions as compared to outside of the set of one or more spatial bounds)) within an environment (e.g., 2D and/or 3D environment), a request to place a user interface (UI) object (e.g., 410, 420, 430, and/or 604) (e.g., as described above with respect to method 500) within the environment (e.g., inside of the set of one or more spatial bounds, outside of the set of one or more spatial bounds, or both inside of and outside of (e.g., some portion inside and some portion outside)). In some examples, a request to place is a request to add, create, generate, move, render, display, and/or cause display of. In some examples, the requested location is explicitly included in the request (e.g., a set of coordinates, position, and/or other indication of location) and/or referenced in the request (e.g., a reference to an identifier of that can be used to determine the requested location). In some examples, the computer system is a phone, a watch, a tablet, a fitness tracking device, a wearable device, a television, a multi-media device, an accessory, a speaker, and/or a personal computing device. In some examples, the computer system is in communication with input/output devices, such as one or more cameras (e.g., a telephoto camera, a wide-angle camera, and/or an ultra-wide-angle camera), speakers, microphones, sensors (e.g., heart rate sensor, monitors, antennas (e.g., using Bluetooth and/or Wi-Fi), fitness tracking devices (e.g., a smart watch and/or a smart ring), and/or near-field communication sensors). In some examples, the computer system is in communication with a display generation component (e.g., a projector, a display, a display screen, a touch-sensitive display, and/or a transparent display). In some examples, receiving the request to place the UI object includes detecting, via one or more input devices in communication with the computer system, an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location).

At 904, after providing the request to place the UI object (e.g., 410, 420, 430, and/or 604) within the environment receiving: data representing a location of the UI object within the environment (e.g., within the spatial bounds, outside of the spatial bounds, or both); and in some examples, the request is successful if it (e.g., including the requested UI object) satisfies a set of one or more criteria (e.g., permitted type of object, permitting location, permitted distance, and/or does not cover application content and/or window chrome or covers by an acceptable amount). In some examples, the application does not receive the data representing the location of the UI object if the request is not successful. data representing a location of at least a portion of content (e.g., the UI object, a portion of the application such as window chrome (e.g., a toolbar and/or other interactable portion of the window), and/or content from inside of the application window) corresponding to the application (e.g., 350) that is outside of the set of one or more spatial bounds (e.g., the dotted line in FIG. 4)) in the environment. In some examples, in response to receiving the request to place the UI object within the environment and in accordance with a determination that the request satisfies the set of one or more criteria, a computer system places the UI object. In some examples, placing the UI object includes one or more of: displaying, causing display of, rendering, and/or permitting display of, and/or enabling interaction (e.g., user interaction and/or interaction with other UI objects) with the UI object in the environment. In some examples, placing the UI object does not include displaying the UI object in the environment. In some examples, displaying the UI object includes displaying a graphical and/or visual representation of the UI object. In some examples, the request is successful if it (e.g., including the requested UI object) satisfies a set of one or more criteria (e.g., permitted type of object, permitting location, permitted distance, and/or does not cover application content and/or window chrome or covers by an acceptable amount). In some examples, the application does not receive the data representing the location of the UI object outside of the spatial bounds if the request is not successful. In some examples, the application receives data representing the location of the UI object inside of the spatial bounds if the request is not successful.

Note that details of the processes described above with respect to method 900 (e.g., FIG. 9) are also applicable in an analogous manner to other methods described herein, including methods 500, 700, and/or 800. For example, method 800 optionally includes one or more of the characteristics of the various methods described above with reference to method 900. For example, the request of method 800 can be the request of method 900. For brevity, these details are not repeated below.

Below are some examples of how one or more features of the above described techniques can be implemented. In the description below, the phrase “out-of-bounds UI object” (or a variation thereof, such as “OOB UI Object” and/or “OOBUIObject”) is used to refer to a UI object (e.g., referenced in a request and/or as a property of a UI object) that is permitted to be placed outside of spatial bounds of an application.

In some examples, OOB UI Objects are a two-dimensional framework feature. In some examples, OOB UI Objects are added to a property on UIViewController:

```
  “‘begin code
  class ViewController: UIViewController {
    override func viewDidLoad( ) {
    super.viewDidLoad( )
    self.OOBUIObjects = [
      UIHostingOOBUIObject(sceneAlignment: .trailing,
      contentAlignment: .leading)
{
      HStack {
        Button { [weak self] in
        self?.buttonTapped( )
        } label: {
        Image(systemName: ″textformat.alt″)
        }
      }
      .glassBackgroundEffect(in: .rect(cornerRadius: 8))
      }
    ]
    // ...
    }
  }
  “‘
```

As explained above, in some examples, OOB UI Objects can be tied to a UIViewController. In some examples, presentation/dismissal is handled by the system. In some examples, when a view controller appears, its OOB UI Objects will automatically (e.g., without intervening user input) appear as well. In some examples, OOB UI Objects will automatically (e.g., without intervening user input) disappear when the view controller disappears. In some examples, based on a determination that the view controller is visible, adding or removing an OOB UI Object from an array will instantly make the OOB UI Object appear or disappear. In some examples, when pushing a view controller onto a navigation controller or switching tabs in a tab bar controller, the OOB UI Objects associated with the previous view controller will disappear while the ones associated with the new view controller will appear. In some examples, an OOB UI Object is always visible in if the OOB UI Object is associated with the tab bar/navigation controller itself.

```
  “‘begin code
  @available(phone operating systems, unavailable)
  @available(computer operating system, unavailable)
  @available(media operating system, unavailable)
  @available(wearable operating system, unavailable)
  @available(mixed reality operating system 1.0, *)
  extension UIViewController {
    /// The OOB UI Objects that are displayed when the associated view controller is
visible.
    public var OOBUIObjects: [UIOOBUIObject]
  }
  “‘
  :
  “‘begin code
  /// The abstract base class that represents an OOB UI Object.
  /// In some examples a user does not create an instance of this class directly. Instead
In some examples, a user uses ‘UIHostingOOBUIObject‘.
  @available(phone operating system, unavailable)
  @available(computer operating system, unavailable)
  @available(media operating system, unavailable)
  @available(wearable operating system, unavailable)
  @available(mixedreality operating system OS 1.0, *)
  public class UIOOBUIObject { }
  @available(phone operating system, unavailable)
  @available(computer operating system, unavailable)
  @available(media operating system, unavailable)
  @available(wearable operating system, unavailable)
  @available(mixed reality operating system 1.0, *)
  /// A model that represents an OOB UI Object suitable for being hosting in two-
dimensional framework.
  public class UIHostingOOBUIObject<Content: View>: UIOOBUIObject {
    /// The guide for aligning the OOB UI Object's content
    /// (based on the ‘contentAlignment‘) with the scene.
    public var sceneAlignment: Alignment
    /// The alignment in the OOB UI Object used to position it.
    public var contentAlignment: Alignment
    /// The root view of the two-dimensional framework view hierarchy managed by this
OOB UI Object.
    public var rootView: Content
    /// Creates an OOB UI Object with the specified alignment and content.
    ///
    /// - Parameters:
    /// - sceneAlignment: The guide for aligning the OOB UI Object's content
    /// (based on the ‘contentAlignment‘) with the scene.
    /// - contentAlignment: In some examples, the alignment in the OOB UI Object
used to position it.
    /// - content: The content of the OOB UI Object.
    public init(
    sceneAlignment: Alignment,
    contentAlignment: Alignment = .center,
    @ViewBuilder content: ( ) −> Content
    )
  }
  “‘
```

In some examples, the extension of UIViewController is live in a two-dimensional framework.

In some examples, OOB UI Object is called “Window Accessory”, “Detached/Anchored View”, and/or “Palette”.

In some examples, two-dimensional framework API is a modifier. In some examples, two-dimensional framework is configured to be employed within two-dimensional framework code with a UIHostingController. In some examples, mixed reality operating system supports the minimal amount for two-dimensional framework. In some examples, it is not 3D-aware. In some examples, OOB UI Objects are not first class in two-dimensional framework. However, as mentioned above, in some examples, two-dimensional framework apps present OOB UI Objects without rewriting part of the app or relying on UIHostingController.

In some examples, the proposed API (e.g., for requesting and/or managing placement of OOB UI objects) associates OOB UI Objects with a view controller. In some examples, OOB UI Objects are directly tied to the scene. In some examples, OOB UI Objects are directly tied to the scene the view controller. For example, tying to the view controller can be advantageous in order to make the OOB UI Objects react to a presentation on their associated view controller and vice versa (e.g., dimming or depth displacement). It can also provide lifecycle tying for free, which can be useful in the case of a navigation or tab bar for example. In some examples, OOB UI Objects are made relative to the view controller or other OOB UI Objects. Finally, it can make the API easier to use as developers have access to the view controller more easily than to the scene.

OOB UI Objects can be used to expand the user interface of apps and add new elements around a scene, taking advantage of the extra space offered by the platform and the new system design. The most common use-case in first-party apps is for placing toolbars/palettes (e.g., examples of OOB UI Objects) around the main window. The original proposal was proposing making a Bar element placement available on mixed reality operating system and use it to make bottom OOB UI Objects.

In some examples, a toolbar two-dimensional framework modifier is used to place content in an OOB UI Object as a high-level API. In some examples, this OOB UI Object will can have a capsule-shaped translucent background and be anchored on the middle of the bottom edge, with an offset. For this, we introduce a new bottom OOB UI Object toolbar item placement. For example, a user would do the following:

```
  “‘begin code
  var body: some View {
    Text(″Hello″)
    .toolbar {
      ToolbarItem(placement: .bottomOOB UI Object) {
```

```
Button {
  // Action
} label: {
  Image(systemName: ″textformat.alt″)
}
```

```
      }
    }
  }
  “‘
  “‘begin code
  extension ToolbarItemPlacement {
    /// Places the item in an OOB UI Object under the window.
    @available(operating system, unavailable)
    @available(computer operating system, unavailable)
    @available(media operating system, unavailable)
    @available(watchOS, unavailable)
    @available(mixed reality operating system 1.0, *)
    public static let bottomOOBUIObject: Self
  }
  extension ToolbarPlacement {
    /// The bottom OOB UI Object of an app.
    @available( phone operating system, unavailable)
    @available(computer operating system, unavailable)
    @available(media operating system, unavailable)
    @available(wearable operating system, unavailable)
    @available(mixed reality operating system 1.0, *)
    public static var bottomOOB UI Object: Self
  }
  “‘
  “‘begin code
  extension ToolbarItemPlacement {
    /// Creates a unique accessory bar placement.
    ///
    /// In some examples, on a computer operating system, items with an accessory bar
placement are placed in a section
    /// below the title bar and toolbar area of the window. Each separate
    /// identifier will correspond to a separate accessory bar that is added to
    /// this area.
    ///
```

| | |
|---|---|
| /// | extension ToolbarItemPlacement { |
| /// | static let favoritesBar = accessoryBar(id: ″com.example.favorites″) |
| /// | } |
| /// | ... |
| /// | BrowserView( ) |
| /// | .toolbar { |
| /// | ToolbarItem(placement: .favoritesBar) { |
| /// | FavoritesBar( ) |
| /// | } |
| /// | } |

```
    /// - Parameter id: A unique identifier for this placement.
    @available(phone operating system, unavailable)
    @available(computer operating system 13.0, *)
    @available(media operating system, unavailable)
    @available(wearable operating system, unavailable)
    @available(mixed reality operating system, unavailable)
    @_backDeploy(before: computer operating system 14.0)
    public static func accessoryBar<ID: Hashable>(id: ID) −> ToolbarItemPlacement
  }
  extension ToolbarPlacement {
    /// Creates a unique accessory bar placement.
    ///
    /// In some examples, on computer operating system, accessory bars are in a section
below the title bar and
    /// toolbar area of the window. In some examples, each separate identifier will
correspond to
    /// a separate accessory bar that is added to this area.
    ///
    /// Use a custom placement to control the appearance of the containing bar
    /// for items using a custom “ToolbarItemPlacement“ with the same
    /// identifier.
    ///
```

| | |
|---|---|
| /// | private let favoritesBarID = ″com.example.favoritesBar″ |
| /// | extension ToolbarItemPlacement { |
| /// | static let favoritesBar = accessoryBar(id: favoritesBarID) |
| /// | } |
| /// | extension ToolbarPlacement { |
| /// | static let favoritesBar = accessoryBar(id: favoritesBarID) |
| /// | } |
| /// | ... |
| /// | BrowserView( ) |
| /// | .toolbar { |
| /// | ToolbarItem(placement: .favoritesBar) { |
| /// | FavoritesBar( ) |
| /// | } |
| /// | } |
| /// | .toolbar(.hidden, for: .favoritesBar) |

```
    ///
    /// - Parameter id: A unique identifier for this placement.
    @available(phone operating system, unavailable)
    @available(media operating system, unavailable)
    @available(wearable operating system, unavailable)
    @available(mixed reality operating system, unavailable)
    @_backDeploy(before: computer system operating system 14.0)
    public static func accessoryBar<ID: Hashable>(id: ID) −> ToolbarPlacement
  }
  “‘
```

In some examples, the placement of accessoryBar is for OOB UI Objects. This can have the advantage of relying on existing API instead of introducing a new symbol. In some examples, accessoryBar is configurable with a phone operating system. In some examples, accessoryBar is used to place content under the navigation bar. In some examples, accessoryBar does not differ between the two different platforms. In some examples, the usage of accessoryBar on computer operating system is different from the usage of an OOB UI Object.

As described above, one aspect of the present technology is the gathering and use of data available from specific and legitimate sources for providing content. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of personal information data, in the present technology, can be used to the benefit of users. For example, the personal information data can be used for providing content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of techniques for rendering content, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 10 illustrates an electronic system 1000 with which some examples of the subject technology may be implemented. The electronic system 1000 can be, and/or can be a part of, the electronic device 105, the handheld electronic device 104, the electronic device 110, the electronic device 115, and/or the server 120 as shown in FIG. 1. The electronic system 1000 may include various types of computer readable media and interfaces for various other types of computer readable media. The electronic system 1000 includes a bus 1008, one or more processing unit(s) 1012, a system memory 1004 (and/or buffer), a ROM 1010, a permanent storage device 1002, an input device interface 1014, an output device interface 1006, and one or more network interfaces 1016, or subsets and variations thereof.

The bus 1008 collectively represents all system, peripheral, and chipset buses that communicatively connect the numerous internal devices of the electronic system 1000. In some examples, the bus 1008 communicatively connects the one or more processing unit(s) 1012 with the ROM 1010, the system memory 1004, and the permanent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different examples.

The ROM 1010 stores static data and instructions that are needed by the one or more processing unit(s) 1012 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In some examples, a mass-storage device (such as a magnetic or optical disk and its corresponding disk drive) may be used as the permanent storage device 1002.

In some examples, a removable storage device (such as a floppy disk, flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random-access memory. The system memory 1004 may store any of the instructions and data that one or more processing unit(s) 1012 may need at runtime. In some examples, the processes of the subject disclosure are stored in the system memory 1004, the permanent storage device 1002, and/or the ROM 1010 (which are each implemented as a non-transitory computer-readable medium). From these various memory units, the one or more processing unit(s) 1012 retrieves instructions to execute and data to process in order to execute the processes of some examples.

The bus 1008 also connects to the input and output device interfaces 1014 and 1006. The input device interface 1014 enables a user to communicate information and select commands to the electronic system 1000. Input devices that may be used with the input device interface 1014 may include, for example, alphanumeric keyboards and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. Some examples may include devices that function as both input and output devices, such as a touchscreen. In these examples, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1008 also couples the electronic system 1000 to one or more networks and/or to one or more network nodes, such as the electronic device 110 shown in FIG. 1, through the one or more network interface(s) 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some examples include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some examples are performed by one or more integrated circuits, such as application specific integrated circuits (ASICs) or field programmable gate arrays (FPGAs). In some examples, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, some examples of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an example of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some examples, a server transmits data (e.g., an HTML page) to a client device (e.g., for purposes of displaying data to and receiving user input from a user interacting with the client device). Data generated at the client device (e.g., a result of the user interaction) can be received from the client device at the server.

Some examples within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some examples, the tangible computer-readable storage medium can be directly coupled to a computing device, while in other examples, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, some examples are performed by one or more integrated circuits, such as ASICs or FPGAs. In some examples, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In some examples, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In some examples, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more examples, some examples, other examples, such examples, one example, for example, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other examples. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving, from an application associated with a set of one or more spatial bounds within an environment, a request to place a user interface (UI) object at a location outside of the set of one or more spatial bounds; and
in response to receiving the request to place the UI object at the location that is outside of the set of one or more spatial bounds and in accordance with a determination that the UI object has a first property and that the location satisfies a set of one or more distance criteria, placing the UI object within the environment and outside of the one or more spatial bounds.

2. The method of claim 1, further comprising:
in response to receiving the request to place the UI object at the location that is outside of the set of one or more spatial bounds and in accordance with a determination that the UI object has a second property different from the first property, forgoing placing the UI object within the environment and outside of the one or more spatial bounds.

3. The method of claim 1, further comprising:
while the UI object is displayed in the environment, receiving an indication of an interaction corresponding to a respective location that is outside of the one or more spatial bounds; and
in response to receiving the interaction and in accordance with a determination that the respective location corresponds to a location of the UI object, sending, to the application, an indication of the interaction.

4. The method of claim 1, wherein the request to place the UI object is received by a system process of a computer system.

5. The method of claim 1, wherein the UI object includes a plurality of controls, and wherein a respective control of the plurality of controls is configured to, when selected, cause one or more computer systems to perform an operation with respect to the application.

6. The method of claim 1, wherein the UI object includes one or more characteristics, and wherein placing the UI object includes, in accordance with a determination that the one or more characteristics are not specified by the request to place the UI object, applying one or more default characteristics to the UI object.

7. The method of claim 1, wherein the request to place the UI object includes a size for the UI object.

8. The method of claim 7, wherein the UI object is displayed:
in accordance with a determination that the size satisfies a first set of one or more size criteria, in the size; and
in accordance with a determination that the size does not satisfy the first set of one or more size criteria, in a second size different from the size.

9. The method of claim 1, wherein the request to place the UI object includes a specified location for the UI object.

10. The method of claim 9, wherein the UI object is displayed:
in accordance with a determination that the specified location satisfies the set of one or more distance criteria, at the specified location; and
in accordance with a determination that the specified location does not satisfy the set of one or more distance criteria, at a second location different from the specified location.

11. The method of claim 1, wherein the UI object corresponds to a view of the application, and wherein the UI object ceases to be displayed in conjunction with the view ceasing to be displayed.

12. The method of claim 1, wherein the UI object changes from a first visual appearance to a second visual appearance different from the first visual appearance in conjunction with the application becoming a background process.

13. The method of claim 1, wherein the UI object changes from a third visual appearance to a fourth visual appearance different from the third visual appearance in conjunction with a user interface element corresponding to a system process being displayed.

14. The method of claim 1, further comprising:
after placing the UI object in the environment, receiving a request to move the set of one or more spatial bounds within the environment; and
in response to receiving the request to move the set of one or more spatial bounds within the environment, causing the UI object to move from a first location to a second location within the environment, wherein the second location is different from the first location.

15. A non-transitory computer-readable storage medium storing one or more programs configured to be executed by one or more processors of a computer system, the one or more programs including instructions for:
receiving, from an application associated with a set of one or more spatial bounds within an environment, a request to place a user interface object at a location outside of the set of one or more spatial bounds; and
in response to receiving the request to place the UI object at the location that is outside of the set of one or more spatial bounds and in accordance with a determination that the UI object has a first property and that the location satisfies a set of one or more distance criteria, placing the UI object within the environment and outside of the one or more spatial bounds.

16. A computer system, comprising:
one or more processors; and
memory storing one or more programs configured to be executed by the one or more processors, the one or more programs including instructions for:
receiving, from an application associated with a set of one or more spatial bounds within an environment, a request to place a user interface object at a location outside of the set of one or more spatial bounds; and
in response to receiving the request to place the UI object at the location that is outside of the set of one or more spatial bounds and in accordance with a determination that the UI object has a first property and that the location satisfies a set of one or more distance criteria, placing the UI object within the environment and outside of the one or more spatial bounds.
